(19) United States
(12) Patent Application Publication
(10) Pub. No.: US 2005/0076772 A1
(43) Pub. Date: Apr. 14, 2005

(54) Music composing system

(76) Inventor: Andrew Price Gartland-Jones, East Sussex (GB)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/683,484

(22) Filed: Oct. 10, 2003

(51) Int. Cl. H04Q 1/00; G10H 1/18; G10H 7/00

(52) U.S. Cl. 84/615

(57) ABSTRACT

A music composing system comprises a plurality of music composing blocks 20, 30, 40, 50, 60. Each block comprises a music composing means 16 for composing modified music based on initial and target music sections provided to the block. Block 20 stores initial music I₂. When a user places block 20 within a predetermined range of block 30, block 20 transmits its initial music section 12 over a wireless Local Area Network 100 to block 30. Block 30 then composes a modified section of music M₃ on the basis of its initial music section I₃, using the received initial music I₂ of block 20 as a target. Block 30 produces a plurality of copies of initial music I₃, and mutates each copy of the music to provide a plurality of mutated sections of music. Block 30 assesses the similarity of the mutated sections of music to the target, I₂, and retains those mutated sections which are more similar to I₂ than its initial music I₃. Block 30 continues to mutate successive generations of music sections until a section with a similarity of 50% to the target I₂ is produced. Block 30 then outputs this mutated section of music as its modified music M₃. Block 40 receives M₃, and uses it as the target in a composition process based on its initial music I₄, to produce a modified section of music M₄. Block 40 then begins to play its modified music M₄ for assessment by a user. The process is continued to provide music for the entertainment of the user.

### BACKGROUND OF THE INVENTION

1. Field of the Invention

The present invention relates to a system for composing music, and more particularly to a system for the automated composition of music.

2. Description of the Related Art

Automated systems for composing music are known. Typically such systems are rule based, with music being generated using algorithms based on an analysis of the character of the type of music the system is intended to produce. For example, information to describe the character of the music may be derived through a statistical analysis of the music, and used to produce a set of rules such that the structure of any music generated on the basis of rules will reflect this character. More recently learning based systems have been used, in which the system is “taught” a set of rules to be used when composing music by “training” it using examples of music in a style which it is to emulate. These systems analyse the character of the examples to derive the information to be used when composing music, for example using a neural network. One problem with using rule based composition systems such as these is that the music produced will be constrained by the need to adhere to a formalistic structure which may be described using rules, and may therefore fail to capture the unpredictability or variation associated with human composition.

A further technique which has been used to automatically compose music uses genetic algorithms. Typically the genetic algorithms randomly generate a number of possible mutations of an initial section of music (the “seed” music). Often this “seed music” is itself a randomly generated section of music. The extent to which the genetic algorithm is allowed to search for mutations of the seed music may be constrained by using rules based on the structure or style of the music it is desired to produce.

One problem with a genetic algorithm based system is that it is necessary to assess the many mutated fragments produced to select those of musical interest. Although such an assessment may be carried out by a human, manual assessment of the results is a time consuming and labour intensive process. More usually assessment is carried out automatically, using a predetermined set of rules. Thus although genetic algorithm based systems may, to an extent, replicate more closely the activities of a human composer in developing and modifying an initial musical idea, such systems are still generally constrained to some extent by the need to use a set of rules adhering to a formal musical structure.

Genetic algorithms have also been used to create a musical path between an initial section of music and a target section of music using rules derived from the target music. However, such methods do not allow a user to influence the development of the musical path between the initial and target sections of music.

The Applicant has realised that there remains a need for an improved system for composing music, which is automated, but yet still allows a user to influence the development of the music, and which provides greater freedom from constraints to the music structure than known automated musical composition techniques allow.

### SUMMARY

According to a first aspect of the present invention there is provided a system for composing music, comprising:
a plurality of music composing modules, each module comprising means for composing a modified section of music using initial and target music sections provided to the music composing module;
wherein:
the plurality of music composing modules can be interfaced with one another such that the initial, target, or modified music section of a first music composing module interfaced with a second music composing module becomes the initial or target music section for the second music composing module.

According to a second aspect of the present invention, there is provided a method of composing music using a plurality of music composing modules, each module comprising means for composing a modified section of music using initial and target music sections provided to the music composing module, the method comprising:
interfacing one or more of the music composing modules with one another such that the initial, target, or modified music section of a music composing module interfaced with another music composing module becomes the initial or target music section for the another music composing module.

In the present invention, a plurality of music composing modules each comprising means for using initial and target music sections to compose a modified music section may be interfaced with one another such that the initial, target or modified music section of one module becomes the initial or target music section of another module of the system.

This allows the initial or target music section of a module (which will then be used to derive the composed modified music section of that module) to be chosen and altered simply by changing the way in which the modules are interfaced with one another. The system of the present invention thus allows, e.g. a user of the system to influence the characteristics of the music composed by the modules simply by arranging the modules such that they are interfaced in a particular way. In particular, should the user hear music from a module that they like, they can use that music to influence the music composed by other modules of the system by interfacing those modules with the module producing the pleasing music. The Applicants believe that this provides a more flexible music composing system but which can be relatively easily used and influenced by even a nonmusically skilled user.

The present invention also extends to a music composing module for use in the music composing system of the present invention.

Thus, according to a third aspect of the present invention, there is provided a music composing module for use in a music composing system, the module comprising:
means for composing a modified section of music using initial and target music sections provided to the music composing module;
means for transmitting the initial, target, or modified music section of the music composing module to another music composing module; and
means for receiving the initial, target, or modified music section of another music composing module.

It is, as discussed above, preferred that the music composing module of this aspect of the invention transmits and/or receives the music section(s) when it is interfaced with another music composing module. Thus, the music composing module preferably comprises means for interfacing the music composing module with another music composing module of the system.

The individual music composing modules can be implemented as desired. In one preferred embodiment they are implemented “virtually” e.g., using computer software, preferably as icons on an appropriate display screen. In another particularly preferred embodiment they are implemented as physical blocks, for example plastic or wooden blocks, which contain any necessary electronics and components to implement the music composing and interfacing functions, and which may be manipulated by the user to provide a desired interface between the modules in use. The modules accordingly preferably comprise one or more processors for implementing their various functions, such as the composing and interfacing instructions, that are described herein. As will be appreciated by those skilled in the art, a module may use a single processor, or a plurality of processors. For this purpose the modules preferably include one or more memories for storing data and information such as the initial target and modified music sections that they require in use. As will be discussed in more detail below, this data, such as the music sections, may be pre-stored in the modules or may, e.g. be transmitted from other modules of the system, or e.g. from a system controller, in use (and then stored (even if only temporarily) by a module in use).

The music composing modules may be interfaced by placing the modules in physical contact with one another, or by providing a physical connection, e.g. wires between the modules. Preferably the modules are provided with interlocking co-operating formations to allow the modules to be releasably connected to one another. Additionally or alternatively, the modules could be interfaced with one another by bringing the modules within a given range of one another, and need not necessarily require the modules to be in physical contact.

The music composing modules should include means whereby they can recognise that they have been interfaced with another module. Preferably the modules thus comprise means for transmitting a signal to indicate their presence in a given range. This signal may then be received by another module of the system, to allow the other module to recognise that it is interfaced with the first module. Preferably the presence signal transmitted by a module includes an identifier unique to that module. This identifier may then be used by another module of the system receiving the presence signal to identify which module it is interfaced with.

Each music composing module could be interfaceable with one other music composing module of the system only. However, in a particularly preferred embodiment, a and preferably each music composing module can be interfaced with plural other music composing modules simultaneously.

It will be understood that a module may be interfaced with another module situated beside, above or below the module. Most preferably the modules thus transmit presence signals within a given, preferably predetermined range from each of their faces and/or edges, etc., as appropriate. In a particularly preferred embodiment the modules comprise infrared transmitters for this purpose. They preferably also, accordingly, comprise infrared receivers to receive transmissions of e.g. presence signals from other modules of the system.

The modules preferably build up a “map”, so that they know which other modules of the system they are “interfaced” with at any time.

The music sections may be provided in any suitable form for processing by the music composing modules. Preferably the music sections are provided electronically, most preferably in a digital form. For example, the music sections may be represented as MIDI files, or bit arrays. Preferably note information describing the properties of individual notes in the music section and music section information describing properties of the music section as a whole are provided. For example, the note information may include e.g. velocity, pitch and duration of the notes. Preferably at least pitch information is provided. For example, this information may be provided in an array providing information describing the properties of the notes at each position in the music section. Music section information may include information relating to larger scale features of the music section as a whole e.g. note patterns, key, time signature, mode etc.

The music sections may be of any length or complexity. Generally the most suitable form will depend upon the format used to represent the music sections, and the rate at which a module and/or the system is to process the music sections. For example, the sections may typically be of a few bars' length, and may include a number of different parts, or if representing parts played by different instruments, tracks. Preferably, note information is provided for each part or track of the music section.

As discussed above, the initial, target or modified music section of one module can become the initial or target music section of another module of the system when the modules are interfaced together. In a particularly preferred embodiment, the initial or modified music section of one module becomes the target music section of the other, interfaced module. Most preferably the modified (composed) music section of the first module is used as the target music section of the second receiving module. This allows the music being composed by the modules to evolve more rapidly from the initial music sections of the modules in the system.

The music composing modules should accordingly comprise suitable means for receiving and transmitting music sections from and to other modules of the system when interfaced with those other modules of the system. The transmitting and receiving means of a module may comprise e.g. input or output connectors to allow transmission or receipt of music sections to or from another module with which the module is physically connected.

However, preferably the music is transmitted and received wirelessly. In a particularly preferred embodiment the modules are arranged as and/or are controlled to transmit and received music over a wireless network, preferably a local area network.

In one preferred embodiment, the modules preferably transmit music to and receive music from other modules by means of the same transmitting/receiving means used by the modules to determine when they are interfaced with one another. In one preferred embodiment the music is transmitted and received by means of radio communication. In another preferred embodiment the music is transmitted and received by means of infrared communication.

In another particularly preferred embodiment the modules transmit and receive music sections by radio communication but use infrared communication to determine whether they are interfaced with one another. This is because it is preferred for determining whether a module is interfaced with another module to be a “line of sight” operation (infrared communication requires the receivers and transmitters to be within the line of sight of one another). However, using radio communication to transmit and receive music sections allows music to move around the system more rapidly and a greater volume of information to be processed than infrared communication would allow.

Preferably, each module transmits its relevant music section wirelessly, e.g. out to a given range of the module, such that the music section may then be received as an input by another module of the system, e.g. that is within the given range of the first module. Each module thus preferably comprises means for transmitting and receiving a music section within a given range, preferably a predetermined range, of the module. This arrangement is particularly suitable if the modules are to be arrangeable in a 3D structure. A module may then simultaneously transmit a music section to a plurality of surrounding modules within a given range, allowing the music to evolve more rapidly within the structure. The transmitting means may be arranged to output any or all of the modified, target or initial music of the module to another module of the system.

The modules may automatically transmit music sections when interfaced appropriately. However, preferably the modules transmit music sections only on intervention of the user. For example, the modules may incorporate a button or such like, which, when pressed causes the module to transmit e.g. the modified music section it has produced. The modules preferably also comprise means allowing the user to select the initial, target or modified music section for transmission.

In a particularly preferred embodiment, a composition process is initiated by a module transmitting its initial music to another module of the system, which then composes a modified section of music on the basis of its own initial music with the received initial music from the other module as a target. Preferably the another module then automatically transmits its modified music which may then be received by a further module of the system and used as the target music in a composition process carried out by that module on the basis of its own initial music. In this way, a composition “chain” may be initiated by the transmission of the initial music of the first module, with modified music composed by modules then propagating automatically from one module to the next a given number of times.

It is believed that this is new and advantageous in its own right, and thus from a further aspect the present invention provides a method for composing music using a plurality of music composing modules, each module comprising means for composing a modified section of music using initial and target music sections provided to the music composing module, the method comprising:
providing each module of the system with an initial section of music;
a module transmitting its initial section of music to another music composing module, such that the initial music section of the module becomes the target music of the another music composing module;
the another music composing module composing a modified section of music using the initial section of music transmitted by the first music composing module as its target music section;
and repeating the above transmitting and composing steps a selected number of times with the modified section of music of the another music composing module becoming the target music of a further music composing module.

The steps of a module composing modified music and then transmitting the modified music to another module as the target music for a composition process carried out by that module are preferably repeated a selected, preferably predetermined, number of times, before a modified section of music is output for assessment by the user. The number of transmissions of the modified music before a modified section is output for assessment by the user can preferably be specified e.g. by a user. For example, the user may specify that the music is output after e.g. 5 transmissions.

The influence of the initial music of the first module in the chain preferably decreases progressively with distance from that module. This may be achieved in the preferred embodiment in which a module transmits modified music to become the target music of another module when composing its modified music in a “composition chain” e.g. by designing the system such that similarity to the target of the modified music transmitted by a module is less than was the similarity of the modified music received by that module as the initial music for the composition process to its respective target i.e. the modified music composed by the previous module in the chain. In this way the similarity of the modified music transmitted to its respective target preferably decreases with each subsequent transmission of modified music between modules of the system. For example, a first module may output modified music to a second module when it is 50% similar to the target music. The second module may then transmit modified music based on the target modified music output by the first module when it is 40% similar to the modified music produced by the first module, and so on, until a given number of transmissions of modified music is reached, and modified music is output for assessment by a user.

From a further aspect the present invention thus provides a method for composing music using a plurality of music composing modules, each module comprising means for composing a modified section of music using initial and target music sections provided to the music composing module, the method comprising;
providing each module of the system with an initial section of music;
a module transmitting its initial section of music to another music composing module, such that the initial music section of the module becomes the target music of the another music composing module:
the another music composing module composing a modified section of music using an initial section of music and the target section of music transmitted by the first music composing module;
and repeating the above transmitting and composing steps a given number of times with the modified section of music of the another music composing module becoming the target music of a further music composing module;
wherein the similarity of the modified music transmitted by a music composing module to its target is less than was the similarity of the modified music section transmitted to that module as the target to its respective target.

In a particularly preferred embodiment this process is commenced only on manual intervention of the user and then proceeds automatically thereafter. Thus each module preferably transmits its initial music only on intervention of the user, and transmits its modified music automatically.

It is believed that this is new and advantageous in its own right, and thus from a further aspect the present invention provides a method for composing music using a plurality of music composing modules, each module comprising means for composing a modified section of music using initial and target music sections provided to the music composing module, the method comprising:
providing each module of the system with an initial section of music;
manually intervening to cause a first module to transmit its initial section of music to another music composing module, such that the initial music section of the first module becomes the target music of the another music composing module;
the another music composing module composing a modified section of music using the initial section of music transmitted by the first music composing module as its target music section, and transmitting the modified section of music automatically to another music composing module of the system.

According to a further aspect of the present invention there is provided a system for composing music, comprising:
a plurality of music composing modules, each module comprising means for composing a modified section of music using initial and target music sections provided to the music composing module;
wherein:
each music composing module is arranged to automatically transmit a modified music section it composes to another music composing module of the system and to transmit its initial section of music to another module of the system only on the intervention of a user.

According to a further aspect of the present invention, there is provided a music composing module for use in a music composing system, the module comprising:
means for composing a modified section of music using initial and target music sections provided to the music composing module;
means for automatically transmitting a modified music section composed by the music composing module to another music composing module;
and means for allowing a user selectively to transmit the initial music section of the music composing module to another music composing module.

The music composing modules preferably comprise means for outputting a music section or sections for assessment by a user (and for the entertainment of the user). For example, the modules may comprise means for outputting music sections to electronic processing means for representation graphically. However, most preferably the music composing means comprises means for audibly outputting a music section or sections. This may be achieved indirectly, e.g. by outputting the music electronically for processing by audio output means, or as a sound file for processing by computer software. However, preferably the music composing module comprises audio output means for audibly outputting a music section or sections, such as a loudspeaker. In this way, a user may listen to the output of the module, and, without any musical training, assess the music and determine the effect of changing the way in which the modules are interfaced with one another on the evolution of the music.

A module may output any or all of its initial, target or modified music sections for assessment by the user depending, for example, upon the manner in which the system is to operate, and preferably may output different music sections at different times. For example, a module may output a modified section of music for assessment by a user as soon as it is produced. In such arrangements a module preferably outputs its initial music section until such time as it has composed a modified music section, when it then begins to output the modified music section instead.

However, in preferred embodiments as discussed above, where a module passes its modified music onto a further module with which it is interfaced, and the further module then composes a modified section of music using the received modified music of the first module as its target with the further module then transmitting its modified music to another module and so on (i.e. where the modules are effectively arranged to act as a “composition chain”), the audible outputs of the intermediate modules are preferably suppressed, such that only the module at the end of the chain outputs its modified music audibly, to allow the result of that composition chain to be assessed by the user. Preferably, the first module at the start of the chain outputs its initial music until the final module begins to output its modified music.

The initial music section for a or each module may be preset e.g. on manufacture of a module. However preferably the initial music section can be and is supplied to the module by a user. This will allow the user greater ability to influence the properties of the modified music section produced by the module. This may be achieved, e.g., by the user inputting an initial section of music directly, e.g. as a sound file, or the module could comprise means for recording a music section played to it by a user. Alternatively a or each module may comprise e.g. neural network means allowing it to “learn” music from examples of music preferred by the user.

In other arrangements, a module may be provided with an initial music section by interfacing it with other modules of the system in use. For example, a module could store initial or modified music sections received from other modules as its own initial music section. In this way, if the user particularly liked the composed music section generated by one of the modules in the system in use, he could store that music as the initial music section of another module so that it could be used as a starting point in future composition processes.

New initial music may be used for each composition process. However, in a preferred embodiment the initial music remains the same for a plurality of composition processes carried out by a module. In a particularly preferred embodiment, each module is supplied with initial music which remains associated with the module at all times in use. In this embodiment, the initial music may be considered to be the “home” music of a module, providing the module with an identity which remains unchanged as music moves around the system and evolves. As the modules compose modified music sections on the basis of the initial and target music, by maintaining the initial music unchanged for a module as it is moved around the system, all modified music produced by that module will be characterised at least to some extent by the properties of the initial music associated with that module. This allows a user to, for example, select a module whose initial or modified music he likes, and interface that module such that its initial or modified music becomes the target music of another module in the system, knowing that the initial music associated with the first module will influence the modified music produced by the second module for which it is the target.

Each module may thus comprise means for storing an initial music section. However, more preferably the initial music is stored remotely from the modules. For example, a database may be maintained storing initial music associated with each of the modules of the system. Preferably each module thus stores an identifier. This identifier may then be transmitted e.g. to an external network to allow the initial music of that module to be retrieved from a storage means.

The target music section or sections of a or each module can similarly be provided to the modules in any suitable manner, such as in the ways described above with regard to the initial music sections. Thus they could, for example, be preset in the modules, or provided by the user in use. Again, each module preferably comprises means for storing a target music section.

It will be appreciated that when the modules are interfaced together to form a structure, a large amount of music may move around the system at any time, and modules may be continually receiving music transmitted from other modules, and creating modified music for transmission to other modules. The system preferably therefore comprises network management means for controlling the operation of a module when it is interfaced with other modules and a or each module preferably comprises means for communicating with the network management means. In a preferred arrangement the network management means is part of an external network, such as a Local Area Network, that links the modules, and the modules comprise means for connection thereto and communication there with. Most preferably the network is a wireless network. This will avoid interfering with the ability of a user to move modules, and to alter the way in which they are interfaced with one another.

The network management means preferably allows information relating e.g. to the composition processes, transmissions and output of modules to be passed around the system to allow operation of the modules to be coordinated. For example, the network management means may control the audible output of music from a module to prevent music simultaneously being output by neighbouring modules, or prevent a module from receiving further music from other modules for a predetermined time after a previous section of music was received to avoid interference with a composition process which had already commenced.

Preferably a module is controlled to prevent it from communicating with a module with which it has recently communicated. For example, this might be within a selected, preferably predetermined, previous time period or previous number of transmissions. In this way a module may be prevented from e.g. transmitting modified music to that module from which the initial music upon which the modified music is based was received, or alternatively a module may be prevented from receiving transmissions from a module to which it recently transmitted its initial music.

The rules by which the network management means operates may be specified as desired by a user. In a more complex arrangement, the network management means could analyse music produced by modules in various parts of the system, and determine how and when each module should output its music to create a combined effect which is musical. In a preferred such embodiment, which will be discussed further below, the network management means controls the modules of the system to produce modified music sections, which, when combined, results in overall output music having predefined characteristics.

The modules may compose their modified music sections using the initial and target music sections using any suitable automated composition technique. For example, a rule based system may be used, with the modules, e.g., using information from an analysis of the initial and target music sections to derive a set of rules for composing the modified music section.

In such an arrangement, the step of composing the modified music thus preferably comprises deriving corresponding information for the initial and target music sections, and using the derived information to determine a set of rules for composing modified music based on the initial and target music sections. For example, a module may compare the information relating to the pitch distribution in the initial and target music sections, and derive rules for use when composing the modified music which will result in that music exhibiting a pitch distribution which is related to that of both the initial and target music sections, e.g. an average of that of the initial or target music sections, or for example reflecting more closely the distribution of the initial or target music section depending upon the extent to which it is desired for the modified music to evolve from the initial music. Alternatively, the module could comprise e.g. neural network means allowing it to use the initial and target music to “learn” rules for composing the modified music.

A module could derive all of the rules necessary for composing the modified music from an analysis of the initial and target music sections. However, more preferably a or each music composing module has defined for it preset rules for composing music, and uses information derived from an analysis of the initial and target music sections to modify at least some of the preset rules. The preset rules may be set in advance e.g. using conventional rule-based composition software. Alternatively, the rules may be set by “training” the module using examples of music of the general structure or type which the system is to produce, and allowing the module to derive the preset rules on the basis of the examples. In this case, the modules may comprise e.g. neural network means, for using supplied music to derive sets of rules for composing music. This arrangement is particularly advantageous, as it allows a user to train a module or modules using examples of music which he or she likes, so that the module will then produce modified music in the same general style.

One drawback to using rule based composition techniques of the type discussed above to produce the modified music is that the modified music will inevitably be constrained by the supplied or derived rules, limiting the extent to which the modified music may depart from the structure of the initial and target music or surprise the user in the same way as music created by a human composer.

In a particularly preferred embodiment therefore, a module and preferably each module uses a genetic algorithm to compose its modified music section on the basis of the initial and target music sections. In such an arrangement the module or modules will, as is known in the art, produce their modified music sections by mutating the initial music section with reference to the target music section. Although as part of this process a module could simply carry out successive mutations on a single supplied section of initial music, more preferably the module creates a population comprising a plurality of preferably identical sections of the initial music. For example, these may simply be copies of the initial music section provided to the module. The module then carries out mutation of the or each section of initial music.

The mutation operations applied to the initial music section preferably include, for example, one or more of adding or deleting a note, exchanging two notes, transposing a note pitch, mutating the velocity or duration of a note, moving a note, or inverting or reversing a pattern of notes. The nature of the possible mutation operations, and the order in which they are applied to the music may be specified as desired by the user, preset and/or selected with reference to the initial or target music sections. In this way, the mutation operations may be chosen so as to be more likely to produce a “musical” result. Although the mutation operations maybe applied at random, more preferably at least some mutations are selected to increase the likelihood of the initial music section evolving towards the target music section, i.e. to result in mutated music which is more similar to the target music section than the initial music section.

Preferably a module thus uses information derived from analysis of the target music section to select at least some of the mutation operations to be applied to the initial music section. The module may, for example, select mutation operations by reference to e.g. the rhythmic or dynamic properties of the target music section. However it has been found that a wider variation in rhythmic and dynamic properties may be tolerated in the modified music than in harmonic properties whilst still achieving a suitably “musical” output. Preferably the module therefore selects at least one mutation operation to apply to the initial music using information derived from a harmonic analysis of the target music section.

As will be discussed further below, when carrying out harmonic analysis of the target music section, the modules preferably derive information relating to the degree of membership of the target music section to each possible key. In such an arrangement, when carrying out a pitch related mutation operation, for example changing the pitch of a note in the initial music section, or adding a note, the modules preferably use the derived target key information to select a scale to draw a mutated pitch from. In this way the selection of new pitches can be weighted with reference to the probability of the new pitch belonging to a key associated with the target music section.

The or each module may simply select a mutated version of the initial music at random for output to another module as the modified music, or to undergo further mutations. However, more preferably the or each module assesses the similarity of the mutated music to the target music section to determine whether to retain the mutated music section. The assessment of similarity preferably involves analysing the mutated music, and comparing it to the target music. This may be carried out by deriving corresponding information in respect of the mutated music to that derived during analysis of the target music section. Preferably, the similarity is assessed by comparing the properties of notes in corresponding positions in the mutated and target music sections. For example such properties may include e.g. the duration, pitch and velocity of notes. Preferably each part of the modified music is compared to the corresponding part of the target music. The compared properties of the mutated and target music sections may be selected as desired, but preferably the step of assessing the similarity of the mutated and target music sections comprises comparing at least information derived from a harmonic analysis of the music. Most preferably at least the pitches of notes in corresponding positions of the mutated and target music sections are compared. As mentioned above, it has been found that while a significant level of rhythmic or dynamic freedom may be tolerated in the modified music of a module, and indeed is advantageous in providing more “interesting” or “surprising” results, it is preferable to constrain the harmonic development of the initial music section to a greater extent in order to provide suitably “musical” results. Preferably the harmonic analysis of the mutated music is carried out by consideration of the degree of membership of the music to each possible key in accordance with the method described below. This more flexible approach to harmonic analysis will allow the music greater freedom to evolve in an unpredictable or surprising manner while still remaining suitably “musical”.

In a particularly preferred embodiment at least one fitness value describing the similarity of the mutated music to the target music is derived. Separate fitness values for each compared property of the music may be derived, or an overall fitness value determined. One simple way to derive a fitness value would be to assign the mutated music a fitness value on the basis of the number of notes with matching properties in corresponding positions in the mutated and target music sections. For example, each time notes with e.g. matching pitches were found in corresponding positions in the target and mutated music sections, the fitness value for the mutated music could be incremented by one. Preferably, the fitness values are used to derive a percentage similarity of the mutated music section to the target music section. Although the similarity assessment may simply involve determining the extent to which properties of the compared sections of music “match”, more complex techniques may be used, modelling more closely human activity in assessing similarity. For example, this might involve classifying the extent to which patterns of notes are related to one another e.g. harmonically, or for example, whether a note pattern is an inversion of a pattern of notes appearing in a corresponding position in the compared section of music.

The determined degree of similarity of the mutated music section to the target music section is preferably then used to determine whether to retain the mutated music. This can be done as desired. For example, the mutated music could be retained if it exceeds a given level of similarity to the target music section. It will be appreciated that in some circumstances the mutated music may be less similar to the target music than the initial music section, i.e. the music may have evolved further away from the target music section. It is preferred therefore for the step of assessing the similarity of the mutated music to the target music section to comprise determining the similarity of the mutated music section to the target music relative to the initial music section. This may be done by additionally comparing the mutated music or target music to the initial music and effectively provides a measure of the evolution of the mutated music towards the target music. Preferably a percentage similarity of the mutated music to the target music relative to the initial music is determined.

Where a genetic algorithm based system is being used, the, or each module, preferably produces a plurality of mutated sections of music from a population initially comprising a plurality of copies of the initial music section provided to the module. A module preferably then admits a mutated section of music into the population if the similarity of the mutated section of music to the target music exceeds the similarity of an existing member of the population of music sections to the target music section. Most preferably the mutated section of music replaces the existing member of the population.

Where such a population of music sections is provided, each member of the population is preferably used as an initial music section and mutated as described above. The similarity of each mutated section to the target music section is preferably then assessed, and the mutated sections discarded or retained in the population to replace existing members of the population on the basis of the assessment, to thereby provide a new population of music sections that is (overall) closer to the target music section and that can then be used as initial music sections for the next mutation process.

A module may output the or a retained mutated section of music as the modified music for assessment by the user, or for transmission to another module of the system, after a single mutation process. However, preferably a plurality of sets of mutation operations are performed before a music section is output as the modified music section, i.e. such that the output modified music section is more than one generation removed from the original initial music section or population of sections of initial music.

Thus in a particularly preferred embodiment, the above steps are preferably repeated with the mutated music becoming the new initial music or the new population of initial music replacing the original population of initial music as many times as desired. Where successive mutation operations are to be carried out, the modules preferably select further mutation operations to apply to the mutated music sections on the basis of the information derived when assessing the similarity of the mutated music to the target music section.

For example, in a simple case, if a note in the mutated music section matches a note in a corresponding position in the target music section, further mutation operations are preferably selected such that the matching note remains unchanged. A more complex method might involve comparing patterns of notes in the mutated and target music sections to select further mutation operations. For example, a pattern of notes could be assigned a rating to describe its similarity to patterns present in the target music, which might then be used to weight the probability of that pattern of notes being selected for further mutation.

The mutated music may be output to the user or another module as the modified music after a predetermined number of sets of mutation operations have been carried out. However, preferably the mutated music is output as the modified music when the similarity of the mutated music to the target music section reaches a given, selected, preferably predetermined, level. For example, a mutated music section may be output as the modified music section when it has evolved a given, selected amount from the initial music section towards the target, e.g. 10%, or 25% or when the music section exceeds a percentage similarity to the target music section in absolute terms.

In a preferred embodiment, the modified music is output to another module of the system, which then carries out a new composition process with the modified music supplied by the first module as its target.

The genetic algorithm preferably terminates once the modified music is output, but may continue to operate until e.g. the mutated music reaches another given level of similarly to the target music section or has undergone a further given number of sets of mutation operations. The new mutated music may then be output as a new modified music section. A module may, for example, output the mutated music as its modified music section whenever its similarity to the target music section has increased by a given amount e.g. 10%. In such arrangements, after a module outputs a section of modified music, the genetic algorithm preferably continues to operate until a new section of modified music has been produced, at which time the module begins to output the new modified music.

It will be appreciated that in embodiments of the present invention using a genetic algorithm, the user may be presented with modified music for assessment which represents a point on the evolutionary path of the initial music toward the target music. As the system selects a single section of mutated music to be output at a given time as the modified music for assessment by the user, the need for the user to spend considerable amounts of time assessing numerous mutations of the initial music after each set of mutation operations to select a section to undergo further mutation is avoided. However, the user is able to use the output modified music to make decisions as to how to interface the modules to influence the further development of the music on the basis of the way in which the music has evolved.

For example, a user may assess the way in which the music has evolved and decide whether to change the way in which a module is interfaced with surrounding modules e.g. to provide a new target music section if he or she does not like the evolution of the music, or to send the modified music to another module of the system to become the target music section for that module if he or she does like the evolution of the music, or alternatively to leave the music to evolve further.

These arrangements of the present invention thus offer more scope for user interaction than a conventional rule based automated system, or known genetic algorithm based systems which operate to generate a single musical path between initial and target sections of music (and accordingly simply present a single optimised path between the initial and target music, and do not allow the user to influence the development of the music along the path) allow.

It should be appreciated in particular that the purpose of the system in accordance with these arrangements of the present invention is not primarily to reach the target music, but instead to create new and interesting music using the target music sections merely as a guide to allow the user to direct the evolution of the music in a particular way. It is therefore unnecessary for the genetic algorithm to continue to operate until a mutated section of music matching the target music is obtained. Preferably the genetic algorithm is thus terminated before a mutated section of music identical to the target is produced.

It is believed that this method of composing music is new and advantageous in its own right. Thus, according to a further aspect of the present invention there is provided a method of composing music comprising:
providing an initial section of music;
providing a target section of music;
mutating the initial section of music to produce a mutated section of music;
assessing the similarity of the mutated section of music to the target section of music to determine whether to retain the mutated section of music;
repeating the above steps with the mutated section of music becoming the new initial section of music; and
terminating the process when a mutated section of music that has a given, non-identical, degree of similarity to the target section of music is produced.

According to a yet further aspect of the present invention there is provided an apparatus for composing music comprising:
means for providing an initial section of music;
means for providing a target section of music;
means for mutating the initial section of music to produce a mutated section of music;
means for assessing the similarity of the mutated section of music to the target section of music to determine whether to retain the mutated section of music;
means for repeating the above steps with the mutated section of music becoming the new initial section of music; and
means for terminating the process when a mutated section of music having a given, non-identical, degree of similarity to the target section of music is produced.

In a particularly preferred embodiment of the present invention, the modules are controlled to produce modified music sections, which, when combined, result in (overall) output music having predefined characteristics. Preferably a module thus composes its modified music with reference to the character of an overall output “piece” of music of which the modified music it produces is to form a part. For example, the character of the output music may be defined by providing information to describe the development of at least one property associated with the overall output music over time. Preferably therefore information to describe the development of at least one property of the desired overall output music is provided. Such properties may include e.g. dynamics, tempo, note density, harmonic character, pitch range, etc.

In a particularly preferred such embodiment the step of composing the modified music comprises comparing at least one property of the initial music and of the desired overall output music. The modules may then, for example, derive rules to modify a property of this initial music so as to produce modified music having a value for that property closer to that desired in the output music. This may be achieved in the same way as described above in relation to modification of the initial music on the basis of the target music supplied to the module from, e.g. another module of the system.

In these arrangements, a user may specify in general terms how the output music is to develop. For example, he may wish to produce a section of music which is initially quiet, and relatively dissonant in character, with a sparse note density, before becoming gradually louder and more harmonious towards its end. The information describing the development of the output music might therefore be seen as acting as a “target” towards which the modules work when producing sections of modified music, in a similar way to that in which they use the target music provided by another module of the system in accordance with the invention. However, rather than dictating the form of the modified music to be produced, the information provided by the user to describe the development of the output music over time is preferably used as a more general guide, providing a constraining framework within which the modules are to operate when generating their modified music. Thus, preferably a plurality of modules may produce a plurality of different modified music sections, each satisfying the specified output music profile, but potentially in very different ways, depending upon the other constraints imposed on the composition process.

In one preferred arrangement the modules are each assigned a particular section of the desired output music which their modified music is to define alone. In this case, the output music might be defined by the modules each outputting their modified music in turn, or in a, e.g., selected, random, or predefined sequence, etc. However, more preferably at least a part of the output music is defined by the modified music of a plurality of the modules being output simultaneously. In a preferred such arrangement, the modules are assigned to groups, the modified music of each group defining when combined a part or track in the output music.

Where the modules compose their modified music using a genetic algorithm and with reference to the character of the overall output music which the modified music of a plurality of the modules is to define when combined, each module preferably uses the genetic algorithm to compose a modified music section on the basis of the initial and target and/or overall output music. The modules may, for example, compose music on the basis of the initial and overall output music using a genetic algorithm in the manner described above in relation to the initial and target music. In a preferred such embodiment the modules select at least one mutation operation to be applied to the initial music section with reference to the character of the overall output section of music which the modified music of a plurality of the modules is to produce when combined. Additionally or alternatively a module selects the result of at least one mutation operation applied to the initial music section with reference to the output music information.

In such embodiments, a module alternatively, or more preferably additionally, preferably uses information provided to describe the output music section that the modified music of a plurality of the modules is to produce when combined to determine whether to retain a mutated music section. Thus a module preferably compares at least one property of the mutated music section to a determined value for that property in the output music information to determine whether to retain a mutated music section.

The way in which the module may use the output music information to determine whether to retain a mutated section of music is preferably similar to the ways discussed above in which the module uses the target music section to determine whether to retain a mutated section of music. Thus, for example, the module preferably uses information derived from a similarity assessment of the overall output music. For example, if the module determines from the output music information that the music should have a particular dynamic level, the module, preferably, retains only those mutated sections of music having a dynamic level within a given, selected range of that level. Similarly, if the module determines a note density value from the output music information for the beginning of the modified music section that is low, preferably only those mutated sections with relatively sparse note densities in this portion are retained.

According to a further aspect of the present invention there is provided a method of composing music using a plurality of music composing modules, each module comprising means for composing a modified section of music using an initial section of music provided to the music composing module, the method comprising:
providing each music composing module with an initial section of music;
providing information to describe an output section of music to be produced;
each music composing module carrying out the steps of:
mutating the initial section of music to produce a mutated section of music;
and using the output music information to determine whether to retain the mutated section of music.

According to yet another aspect of the present invention there is provided a system for composing music the system comprising:
a plurality of music composing modules, each module comprising means for composing a modified section of music using an initial section of music provided to the music composing module; means for providing each music composing module with an initial section of music;
means for providing information to describe an output section of music to be produced;
each music composing module further comprising means for mutating the initial section of music to produce a mutated section of music;
and means for using the output music information to determine whether to retain the mutated section of music.

From a further aspect of the invention there is provided a method of composing music using a plurality of music composing modules, each module comprising means for composing a modified section of music by mutating an initial music section of music provided to the music composing module, the method comprising:
providing an initial section of music to each of said plurality of music composing modules;
providing information to describe at least one property for an output section of music to be produced; and
the music composing modules using the output music section information when composing their modified music sections.

According to a further aspect of the invention there is provided a system for composing music, the system comprising:
a plurality of music composing modules, each module comprising means for composing a modified section of music by mutating an initial section of music provided to the music composing module;
means for providing an initial section of music to each of said plurality of music composing modules;
means for providing information to describe at least one property of an output section of music to be produced;
wherein each of said music composing modules further comprises means for using the output music information provided to produce said modified music.

As discussed above, in these aspects of the invention the output section of music is a section of music which is to be formed by the modified sections of music output by a plurality of the music composing modules, for example, when played in combination (e.g. successively and/or simultaneously). Thus the output music section information will typically be information that is (provided in) common to the plurality of music composing modules, i.e. such that the same output music information is used by the plurality of music comprising modules.

As mentioned above, the overall output music information is preferably intended to act as a guide for the development of the modified music, rather than as a rigid target towards which the music must evolve. To facilitate this, a or each module preferably selects a value for a property of the output music on the basis of which to select, e.g. a rule or a mutation operation or result, within a selected, preferably, predetermined, range of a value for that property that is specified in the output music information. Most preferably the module selects a value for the property within a range defined by a probability distribution centred on a value specified for that property in the output music information.

In certain cases, the output music information for a property may itself be most appropriately provided in the form of allowed range of values for that property. For example, this may be particularly suitable for note density or pitch property information. A module would preferably then select a value for the property for use to e.g. select a mutation operation or result from the specified allowed range, and most preferably select the value of the property to use from a selected, preferably predetermined, range of the value selected from the allowed range defined in the output music information.

When selecting values for a property for which a range of allowed values is prescribed, the modules may all be controlled to select similar values for the property within the range at any time, or to select different values within the range. Preferably therefore a homogeneity level is provided for the relevant property or properties of the output music to control the homogeneity of the modified music produced by a plurality of the modules in respect of that property or those properties. For example, if it is desired for all of the modules in the system to produce modified music with similar properties in respect of a particular parameter, e.g. dissonance, then the homogeneity should be set to a high level. The modules will then all try to select similar values for that property on the basis of which to select, e.g. a mutation operation or result, within a given range for that property in the output music. If it is desired for the modules to produce music exhibiting a wide spread of values of a parameter within the given range defined by the desired output music, then a low level of homogeneity should be specified.

The (overall) output music information may be preset, but more preferably is supplied by the user. Preferably the user may define the length of the output music. For example, the user may specify that the modules produce modified music, which, when output will combine to produce a section of music which is 30 seconds long, being quiet for the first 5 seconds and dissonant, before becoming gradually louder and more harmonious for the remaining 25 seconds. Each module performing a composition process within this time frame may then refer to e.g., the dynamics and harmonic character information specified for the output music for the appropriate time to select, e.g. any rule or mutation operation or result applied to the initial music relating to dynamic or harmonic properties of the music.

In this example, a module might determine from an analysis of the initial music that the dynamics of the initial music fit the profile specified for the output music, and thus select only mutation operations or results or rules which do not affect the dynamic properties of the initial music. Preferably the module refers to the relevant output music information in real time, i.e. that information specified for the time at which it needs to refer to the information to derive values for properties of the output music. However, it is envisaged that a module might, for example, also or instead select values for the parameter with regard to the properties of the output music specified for a time when it is anticipated that the module will be ready to output its modified music.

It will be appreciated that the greater the extent to which the selection of rules, mutation operations or results is constrained by e.g. preset rules, and/or by reference to the target music section, or a desired output section of music, the more predictable the modified music will be. On the other hand, by allowing the modules greater freedom in the selection of mutation operations or results, the modified music obtained may have a “freer” structure, more likely to surprise the user, but at greater risk of producing an “unmusical” result, and may not evolve so quickly towards the target. The system of the present invention can, in its preferred embodiment at least, be set to either of these “extremes” (and at any point in between) and where it is so “set” would be a matter of, for example, user choice. Indeed, it is an advantage of the present invention that it permits such flexibility in the composition process.

It will be understood that if a module is to use both the output music information and information derived from the target music to select rules, a mutation operation or result, etc., to determine its modified music section, then these sets of information may give conflicting instructions. For example, the profile of the output music may indicate a low note density for the mutated music, while the target music may indicate a high note density for the music.

The way in which such conflicts may be resolved may be specified as desired. This is preferably done using the network management means discussed above. For example, the modules may be controlled to allow the target music section information to take precedence over any conflicting instructions derived from the output music information for some or all properties, or vice versa, depending, e.g., upon the extent to which it is desired for the music to mutate more rapidly towards the target, or conform to the overall output music profile. Alternatively, the conflict might be resolved by considering a third measure of similarity which will not conflict with any output music information, such as a consideration of note intervals.

For example, where a module is to use both the output music information and information derived from the target music to determine whether to retain mutated music sections, then conflicting results may, e.g. be resolved as discussed above in relation to the selection of mutation operations and results.

Thus where a genetic algorithm based system is being used, the, or each module preferably produces a plurality of mutated sections of music from a population initially comprising a plurality of copies of the initial music section provided to the module. A module preferably then admits a mutated section of music into the population if the similarity of the mutated section of music to the target music exceeds the similarity of an existing member of the population of music sections to the target music section and/or its conformance to the desired output music for that time exceeds that of an existing member of the population.

Thus, the similarity of each mutated section to the target music section and/or its conformance to the desired output music is preferably assessed, and the mutated sections discarded or retained in the population to replace existing members of the population on the basis of the assessment, to thereby provide a new population of music sections that is (overall) closer to the target music section and/or the output music and that can then be used as initial music sections for the next mutation process.

Although, as discussed above, the music composing modules preferably compose their modified music using a target section of music, it is also envisaged that one or more or all of the modules could compose their modified music with reference only to the defined characteristics of the overall output section of music which is to be produced.

Thus from a further aspect of the invention there is provided, a method of composing music using a plurality of music composing modules, each module comprising means for composing a modified section of music using an initial music section of music provided to the music composing module, the method comprising:
providing an initial section of music to each of said plurality of music composing modules;
providing information to describe at least one property of an output section of music to be produced;
wherein each of said music composing modules uses the output music information provided when composing their modified music.

From a further aspect of the invention there is provided, a system of composing music, comprising:
a plurality of music composing modules, each module comprising means for composing a modified section of music using an initial section of music provided to the music composing module;
means for providing an initial section of music to each of said plurality of music composing modules;
means for providing information to describe at least one property of an output section of music to be produced;
wherein each of said music composing modules further comprises means for using the output music information provided when composing their modified music.

As discussed above, in these aspects of the invention the output section of music is again a section of music which is to be formed by the modified sections of music output by a plurality of the music composing modules, for example when played in combination (e.g. successively and/or simultaneously. Thus the output music section information will typically be information that is (provided in) common to the plurality of music composing modules, i.e. such that the same output music information is used by the plurality of music comprising modules.

As discussed above, in order to allow a module to compose modified music based on its initial and target music sections, it is preferred for the music composing modules to be able to analyse at least the initial and target music sections, and in preferred embodiments using genetic algorithms the similarity of each mutated section of music produced to the initial and target music is assessed. Such analysis can be carried out as desired, and preferably involves a module deriving a set of parameters to describe the form or structure and other properties of the music sections. Preferably corresponding sets of descriptors are derived for the initial and target music sections. The descriptors may be derived using, for example, a statistical analysis of the music. Suitable techniques for doing this would include such techniques commonly used by known automated music analysis and composition systems.

The descriptors may relate to features of the music, as a whole, or to the properties of the music on a smaller scale, e.g. of individual notes or patterns of notes of the music, or more preferably both. Suitable descriptors relating to the music as a whole preferably include its key, time signature, mode, the intervals between consecutive notes, distribution of repeated notes and/or average pitch distribution of notes. Smaller scale descriptors preferably include the duration of notes, their individual pitches, velocity and/or volume etc. It will be appreciated that at least some of this information may effectively be provided in the electronic or digital representations of the music sections being used. For example, as mentioned earlier, the music sections may be provided in the form of arrays containing information specifying the attributes of the music section and the individual notes it contains.

Preferably a or each module comprises means for carrying out at least a harmonic analysis of the music sections. This preferably involves assigning the music a key in accordance with conventional techniques. However, the Applicant has realised that not all music will necessarily adhere to a form which may be easily be described using the conventional rules of harmony. For example, rather than thinking of the music being in one particular key, it is often more appropriate to think of the music as being, to differing extents, in a number of different keys. In a particularly preferred embodiment therefor, the harmonic analysis comprises the steps of determining a degree of key membership of the music, describing the extent to which the music “belongs” to a plurality of keys, and preferably to each possible key. Preferably the degree of membership of the music to keys associated with a plurality of different modes is determined. In a simple case, this would involve considering the degree of membership of the music to major and minor keys. The degree of membership information may be in the form e.g. of a probability distribution.

The degree of membership of the music to a given key is preferably determined by calculating the number of occurrences of pitches in a scale associated with that key which are present in the music section under consideration. It will be appreciated that the scale need not be a classical scale, but may be any predetermined pattern of pitches, corresponding e.g. to a pentatonic or jazz blues scale.

It is believed that this method of harmonic analysis is new and advantageous in its own right. Thus according to a further aspect, the present invention provides a method of harmonic analysis of a section of music, comprising:
specifying a scale comprising a pattern of pitches; and
determining the number of occurrences in the music section of notes having the pitches associated with the scale for each of a plurality of keys of the scale to thereby derive a degree of membership of the music section to each of the plurality of keys.

According to a yet further aspect, the present invention provides an apparatus for the harmonic analysis of a section of music, comprising:
means for specifying a scale comprising a pattern of pitches; and
means for determining the number of occurrences in the music section of notes having the pitches associated with the scale for each of a plurality of keys of the scale to thereby derive a degree of membership of the music section to each of the plurality of keys.

In a particularly preferred embodiment, this way of carrying out this analysis is done by determining the number of occurrences of a particular pitch in the music section, incrementing the degree of membership of the music to all keys having a scale which contains that pitch, and repeating these steps for all possible pitches. Preferably a total number of occurrences in the music for each pitch is derived. This is believed to be a particularly efficient way of carrying out such analysis. Preferably the most frequently occurring pitch in the music section is determined. This information may then be used in determining the mode of the music, or in creating modified music based on the initial music as discussed below.

The degree of key membership information derived for the music section is preferably used to determine a key or keys to which the music section is considered to belong to the greatest extent. This will typically be the key or keys whose scale(s) have the greatest number of pitch occurrences in the music section being analysed. Although the key or keys of greatest membership may only comprise the key or keys whose scale(s) have a number of associated pitch occurrences equal to the highest value found for any of the keys, it will be appreciated that the harmonic analysis method of the present invention does not necessarily assign a single key to the music, and a plurality of keys of greatest membership may be determined to reflect the differing extents to which the music belongs to the different keys. For example, the keys of greatest membership might be all of those keys whose scales have a number of pitch occurrences exceeding a predetermined threshold, or within a predetermined margin of the number of pitch occurrences associated with the key with the highest degree of membership.

Preferably the harmonic analysis further comprises assigning a mode to the music. Although determining the mode of the music will most commonly involve determining whether the music is major or minor, it should be appreciated that the same method may be applied to other standard modes, such as church modes. Preferably a mode is assigned by comparing the number of keys of greatest membership of the music for each mode. For example, if the music is found to have two major keys of greatest membership and one minor key of greatest membership, the music would be taken as being major.

Alternatively, or in addition to this method, a further test of the mode of the music may be carried out by considering the total number of occurrences of pitches present in a pitch pattern associated with the key or keys of greatest membership for each mode. For example, a suitable pitch pattern would be the root position triad of each key. The music may then be considered to be of a particular mode, e.g. major if the number of pitches present in the pattern associated with the key or keys of greatest membership for that mode exceeds the number of occurrences of pitches of the pitch patterns associated with the key or keys of greatest membership for the other mode.

In another preferred embodiment, a further test of the mode of the music may be carried out in addition to or as an alternative to either or both of the above methods using the most frequent pitch occurrence derived for the music. In this test, if the most frequent pitch is identical to the pitch of one of the keys of greatest membership determined for the music section, then the mode of the music section is taken to be the mode of that key of greatest membership. Preferably the step of assigning a mode to the music section thus comprises determining a most frequent pitch occurrence for the music section, and comparing the most frequent pitch occurrence to the key or keys of greatest membership determined for the music section. It will be appreciated that this method may not always produce a “hit”, i.e. the most frequent pitch occurrence may not be identical to a key of greatest membership determined for the music section, and this method is therefore preferably used in addition to one or both of the previous methods described for assigning a mode to the music section. If more than one test is used, it will be appreciated that the result of one test may be set to override another, if appropriate.

It will be appreciated that the music section may consist of a plurality of parts, or tracks associated with different instruments or voices, such that a number of notes occur simultaneously. Preferably the harmonic analysis is then carried out for a plurality and preferably for all of the, tracks or parts. Preferably a key or keys of greatest membership is therefore determined for each track or part. The key of greatest membership for the music section may, for example, then be taken as that key which is the key of greatest membership for the greatest number of tracks or parts.

The method of assigning a mode to the music section may be applied to a multi-part or track music section by assigning each track or part a mode in the manner described above, and then comparing the total number of positive results for each mode once all or a predetermined number of tracks or parts have been considered. However, preferably pitch occurrence information for the music section as a whole is updated as each track or part is analysed. The mode assignment may then be carried out with reference to the overall pitch occurrence information for the music section.

It will be appreciated from the above that the various described aspects and preferred embodiments of the invention can as appropriate include any one or more of all the preferred and optional features of the invention described herein.

The methods in accordance with the present invention may be implemented at least partially using software e.g. computer programs. It will thus be seen that when viewed from further aspects the present invention provides computer software specifically adapted to carry out the methods hereinabove described when installed on data processing means, and a computer program element comprising computer software code portions for performing the methods hereinabove described when the program element is run on data processing means. The invention also extends to a computer software carrier comprising such software which when used to operate a music composing system or a module for such a system comprising data processing means causes in conjunction with said data processing means said system or module to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In some embodiments, all or parts of the present invention can be accomplished using hardware, software, or a combination of both hardware and software. The software used for the present invention is stored on one or more processor readable storage devices including hard disk drives, CD-ROMs, DVDs, optical disks, floppy disks, tape drives, RAM, ROM, flash memory or other suitable storage devices. In alternative embodiments, some or all of the software can be replaced by dedicated hardware including custom integrated circuits, gate arrays, FPGAs, PLDs, and special purpose processors. In one embodiment, software implementing the present invention is used to program one or more processors. The one or more processors can be in communication with one or more storage devices, peripherals (e.g. speakers, monitors, printers, keyboards, pointing devices, etc.) and/or communication interfaces (network cards, wireless transmitter/receiver, etc.).

### SUMMARY OF DRAWINGS

A number of preferred embodiments of the present invention will now be described in more detail, by way of example only, and with reference to the accompanying drawings, in which:

FIG. 1 is a schematic diagram illustrating a music composing module in accordance with the present invention;

FIG. 2 shows a section of a simple structure formed from a plurality of music composing modules as shown in FIG. 1 illustrating the way in which music may move around the structure;

FIG. 3 is a flow diagram illustrating the steps in the music composition process carried out by the music composing modules in more detail;

FIG. 4 is a flow diagram illustrating the steps of the harmonic analysis method in accordance with the invention in more detail;

FIGS. 4A-D illustrate certain aspects of the harmonic analysis described in FIG. 4 in more detail;

FIG. 4A shows a table of degree of key membership before analysis of the music in accordance with the invention;

FIG. 4B illustrates a table of pitch class occurrence;

FIG. 4C illustrates a completed table of degree of key membership after analysis of one track; and

FIG. 4D illustrates a table of greatest key membership after analysis of one track;

FIG. 5A illustrates a dynamic character profile for an output section of music to be produced when modified sections of music produced by a plurality of the music composing modules are combined;

FIG. 5B illustrates a harmonic character profile for the output music;

FIG. 6A illustrates a pitch range profile for a 2-bar phrase at a given time in the output music;

FIG. 6B illustrates possible pitch distribution profiles to be applied by the modules;

FIG. 6C illustrates the “mid-point between neighbours” setting;

FIG. 6D illustrates a homogeneity of centre of distribution within pitch range control;

FIG. 6E illustrates a force pitch range control;

FIG. 7A illustrates a note placement profile for the output music;

FIG. 7B shows a homogeneity of centre of distribution within note placement range control;

FIG. 7C illustrates note distribution profiles which may be used by the modules;

FIG. 7D illustrates a note density range profile for the output music; and

FIG. 7E illustrates a note density homogeneity control.

### DETAILED DESCRIPTION

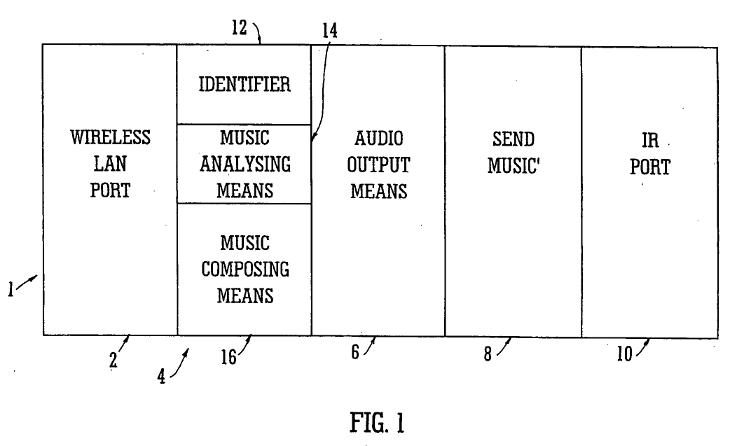

FIG. 1 shows a music composing module 1 in accordance with an embodiment of the present invention. The music composing module is in the form of a wooden building block 1. The block 1 comprises a wireless Local Area Network (LAN) port 2, a processor 4, audio output means 6, an Infra Red (IR) port 10 on each face, and a “send music” button 8 which may be operated by a user to cause the block to transmit a signal via the IR ports 10 on each of its faces indicating that the block is ready to transmit. This signal may be received, as described below, by the IR ports 10 of other blocks of the system which are interfaced with block 1, causing block 1 to transmit music to those other blocks. The processor 4 includes means 10 for storing an identifier 12 associated with the block, music analysing means 14 and music composing means 16 for composing modified music based on initial music and target music sections provided to the block. The block 1 has a wireless LAN port 2 via which it may communicate with a Local Area Network (LAN), to allow it to e.g. transmit music to, and receive music from blocks of the system over the LAN via port 2.

The block 1 may be interfaced with other identical blocks of the music composing system by placing the blocks in physical contact with one another in the manner of building blocks. For example, a 3D structure may be created by placing blocks on, below or to the side of other blocks. However, in the illustrated embodiment the infrared (IR) ports 10 on each face of block 1 transmit a continual or intermittent signal within a predetermined range of the face to indicate the presence and identity of the block. This signal may then be detected by the IR ports 10 on the faces of other blocks of the system located within this range to allow these blocks to recognise that they are “interfaced” with block 1. Conversely, block 1 may detect the presence of other blocks of the system with which it is interfaced via IR ports 10. In this way block 1 may be interfaced with other blocks by bringing the blocks within a predetermined range of one another, and without the need to bring the blocks into physical contact with one another.

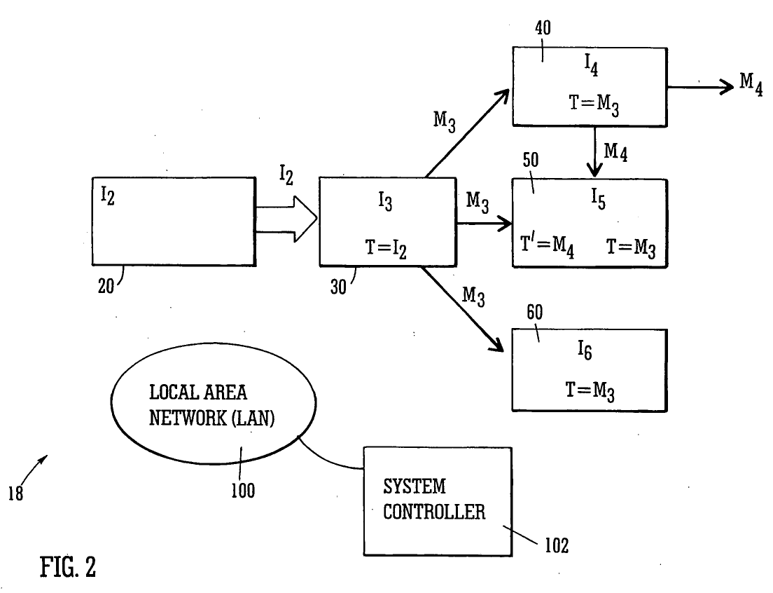

FIG. 2 shows an exemplary structure of a music composing system 18 formed when a plurality of blocks each in accordance with FIG. 1 are interfaced with each other. The music composing system 18 comprises five blocks, 20, 30, 40, 50 and 60, each of identical construction to the block 1 shown in FIG. 1, and which communicate with one another and a system controller 102 over a wireless Local Area Network (LAN) 100 via their respective wireless LAN ports 2.

The system controller 102 communicates with the blocks via LAN 100 and can be used to control the interaction of the blocks with other blocks of the system, as will be described in more detail below, and to store initial music associated with each block in one or more databases accessible via LAN 100.

Corresponding parts of the blocks 20, 30, 40, 50 and 60 will be referred to by the reference numerals used in FIG. 1.

Each block 20, 30, 40, 50, 60 has a respective identifier 12, which maybe transmitted over the wireless LAN 100 via wireless LAN port 2 to allow the respective section of initial music I₂, I₃, I₄, I₅, I₆ associated with that block to be retrieved from a database accessible via wireless LAN 100 and which stores initial music for all of the blocks of the system 18. The initial music may be stored in a database associated with the wireless LAN 100 and associated with the blocks by a user prior to constructing the system 18, or may be prestored before the system 18 is supplied to the user. Although in the embodiments described, the initial music associated with each block is stored remote from the block e.g. in a database associated with LAN 100, it will be appreciated that the initial music may alternatively be stored locally on each block e.g. in a memory accessible by the processor 4.

The initial music is in the form of a 2 bar, 4 part MIDI file. The parts may be associated with different instruments, i.e. such that the music comprises 4 tracks, or may be e.g. vocal parts. The initial music is stored in this embodiment in the form of a section array representing the attributes of the musical section when taken as a whole e.g. tempo, and also containing information specifying the properties of each note that the music section contains. The note information may be held, for example, in a table representing the value for each defined property e.g. pitch, velocity, duration of a note with respect to position in the initial music. The note information may be held, for example, in a table of note objects of dimensions 4×32, representing 4 bars to a resolution of a semi-quaver.

In operation, a user places block 20 in the position shown, and activates it. Block 20 sends its identifier 12 via wireless LAN port 2 over the wireless LAN 100 to retrieve the initial music I₂ associated with block 20 from a database associated with the wireless LAN 100. Block 20 then begins to play its initial music, I2, via audio output means 6. The user then presses the send music button 8 of block 20. This causes the IR port 10 associated with each of the faces of block 20 to transmit a “ready to transmit” signal to be received by any block interfaced with that face. Block 30 is situated such that it has one end face within a predetermined range of block 20. The IR port associated with this face of block 30 registers that it is “interfaced” with block 20, and recognises that block 20 is now ready to transmit. Block 20 then transmits its initial music I₂ over the wireless LAN 100 via wireless LAN port 2 to block 30. Block 30 receives the transmitted music I₂ via its own wireless LAN port 2. In this way, I₂ is received as the target music T for a composition process to be carried out by block 30. The music transmitted by block 20 is not, however, received by blocks 40,50 and 60. This is because blocks 40, 50 and 60 are situated out of the predetermined range of block 20, and the presence signal emitted by block 20 is not detected by their IR ports 10 to indicate that block 20 is a block with which they are interfaced. The music retrieval and transmission take place under the control of system controller 102.

The music composing means 16 of block 30 begins to compose a section of modified music M3 on the basis of its own retrieved initial stored music I3, and the target music I2 received from block 20. The way in which the music composing means produces modified music M3 will be discussed in more detail below.

Once block 30 has composed modified music M3, it signals via the IR ports 10 associated with each of its faces that it is ready to transmit. Blocks 40, 50, and 60 all have faces within a predetermined range of the right end face of block 30. The proximity and identity of block 30 is registered by the IR ports 10 associated with these neighbouring faces of blocks 40, 50, 60, which thus recognise that they are ‘interfaced’ with block 30. Block 30 thus proceeds to transmit its modified music M₃, which is received by blocks 40, 50, 60 via the wireless LAN 100. Although block 20 is also within the predetermined range of a face of block 30, block 30 recognises that it received the initial music I₂ upon which M₃ is based from block 20, and thus does not transmit M₃ to block 30. In this way, the music continues to evolve away from I₂ in subsequent composition processes. The modified music M3 is received by blocks 40, 50 and 60 and becomes the target music in composition processes performed by blocks 40, 50, 60 on the basis of their respective stored initial music 14, 15, 16.

When each of the blocks 40, 50, 60 has completed its composition process, it transmits a ‘ready to transmit’ signal on each of its faces via IR ports 10. For example, Blocks 30 and 50 both recognise that they are interfaced with block 40. However, block 40 recognises that received modified music M3 from block 30, and therefore should not transmit M₄ to it. The modified music M4 of block 40 is thus transmitted via wireless LAN 100 to block 50, but not block 30. Block 50 then carries out a new composition process based on its initial music 15, with M4 becoming its new target music T′. Once block 50 has produced its modified music M₅, it begins to output M₅ via its audio output means 6. Block 20 now ceases to play I₂. The user may then decide whether to press the send music button 8 on block 50 to begin a new chain of composition starting from block 50, e.g. whether to move block 50 to a new location in the structure to influence the development of music in that area.

In the embodiment described above, the initial processing of the ‘send music’ button on block 20 resulted in music being transmitted automatically between the blocks along a chain to block 50 through three transmissions i.e. of I₂ then M₃, and finally M₄, before an output, M₅, was produced for assessment by the user. However, the music could be transmitted through a chain of any length desired, e.g. involving only 2 transmissions, or as many as 10 transmissions. The length of this chain may be specified by the user in advance, or preset via the system controller 102, depending upon the level of user interaction desired. The system controller 102 may also be used to specify other aspects of the operation of the system, for example the predetermined distance between faces of the blocks at which one block considers itself to be interfaced with another block, or to determine whether blocks will accept transmissions of modified music based (indirectly) on their own transmissions. The system could also, for example, be controlled to allow blocks to receive or transmit music from/to other blocks which are interfaced with only certain of their faces.

For simplicity, FIG. 2 illustrates only a section of a possible structure comprising a plurality the music composing blocks in accordance with the invention. Thus while the system illustrated in FIG. 2 contains only five blocks, it will be appreciated that a system may comprise, e.g. up to 100 blocks. It will be understood that similar composition functions will be taking place throughout the structure. As the user listens to the modified music produced by the blocks, he can choose to cause a particular block to transmit its modified music, should he like that music, or, alternatively, if he prefers the modified music being produced in a different part of the structure, he may, for example, exchange blocks in the two areas. As the modified music produced by each block is based on its initial stored music, when a block is moved from one part of a structure to another, any modified music produced by the block in its new position will tend to develop along similar lines to the modified music produced in its old position, as the initial music associated with that block will remain unchanged.

At any one time, a number of composition processes may be occurring in different regions of the structure, and it is likely that more than one block will be playing the composed music it has derived during such a process, or alternatively the initial music associated with it, and which is currently the basis of a composition being carried out in a chain of blocks starting from that block, at any time.

The system controller 102 will receive information from all parts of the system regarding which compositions are occurring at any time, and where there are occurring in the structure, and also what music is being output by the audio output means 6 associated with the blocks for assessment by the user. The system controller 102 may, for example, communicate with blocks via the wireless LAN 100 to prevent a block from playing its modified music if a nearby block is already playing, or control blocks in close proximity to one another to play their modified musical sections sequentially to enable a user to more easily assess the results of the composition processes. The system controller 102 could, for example, control a block to be silent or output its initial music after a specified time, if the user has not caused it to transmit its modified music. The system controller 102 may also allow the user to control the system such that the modified music produced by blocks at intermediate positions in a particular chain of composition is output for audible assessment.

In a more complex system, the system controller 102 may use information provided by the music analysing means 12 to determine which sections of modified or initial music associated with the various blocks of the system would be most compatible if played simultaneously by the audio output means of the respective blocks, and cause those blocks to play their music to provide a combined piece of music based on those musical sections.

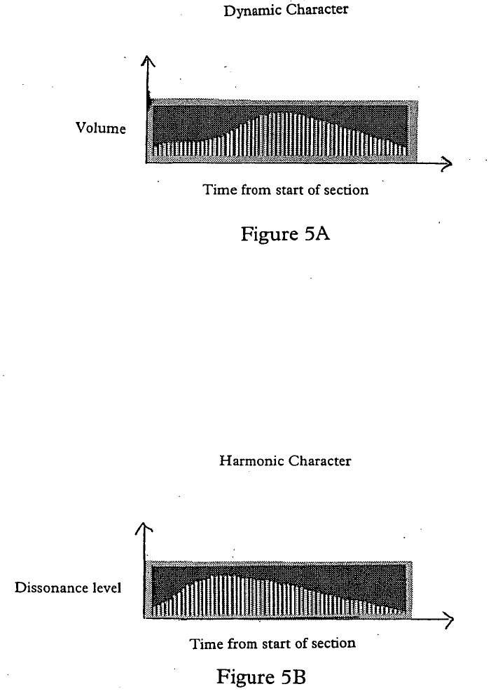

In a preferred arrangement, the system controller 102 is provided with information to describe the character of an overall output section of music which is to be generated by combining modified music produced by the blocks in the structure. This information may be provided in the form of a series of profiles such as graphs illustrating the development of selected characteristics of the desired output music, e.g. dynamics, tempo, note density, harmonic nature, over time. For example, ranges for the parameters may be provided. The compositional process to be carried out at any time by a block may then be directed to some extent with reference to the parameters of the desired output music indicated by the graphs for that particular time frame, as well as by reference to the target music. A way in which this may be achieved is discussed in more detail below with reference to FIGS. 5A-7B.

It will be appreciated that by directing the output of the composition processes occurring in the structure in this way, the likelihood of modified music played simultaneously by different blocks of the system blending together in a ‘musical’ way is enhanced. It is envisaged that further information may be provided to describe how similar the different sections of modified music produced by the blocks should be to one another within the confines of the profile of the desired output music. For example, this information may be provided in the form of a further profile for each parameter describing the desired homogeneity of the modified music being produced by the different blocks in the system with one another over time. Thus if it is desired for the blocks to all produce modified music with relatively similar values of a given parameter, the homogeneity graph for that parameter may be set to a high value in that timeframe. If a lower level of homogeneity is prescribed, the blocks will attempt to produce modified music with a greater spread of values of the parameter within a range prescribed for the output music.

Information describing the profile of the desired output music and the extent to which blocks should attempt to produce homogenous outputs when performing composition processes may be preset, or more preferably may be defined by a user at the start of a new composition process, and altered during it.

Although in the embodiment described, the send music button 8 results in a block transmitting its modified music, it will be appreciated that the blocks may instead be configured to transmit their initial music, or might be provided with more than one send music button associated with the modified or initial music, allowing a user to select which section of music to transmit. It might also be envisaged that a block could include means to allow the user to store a modified section of music produced to replace the initial music stored in a database associated with LAN 100 and associated with that block at any stage in the process, should the user particularly like the way in which the music produced by that block has evolved.

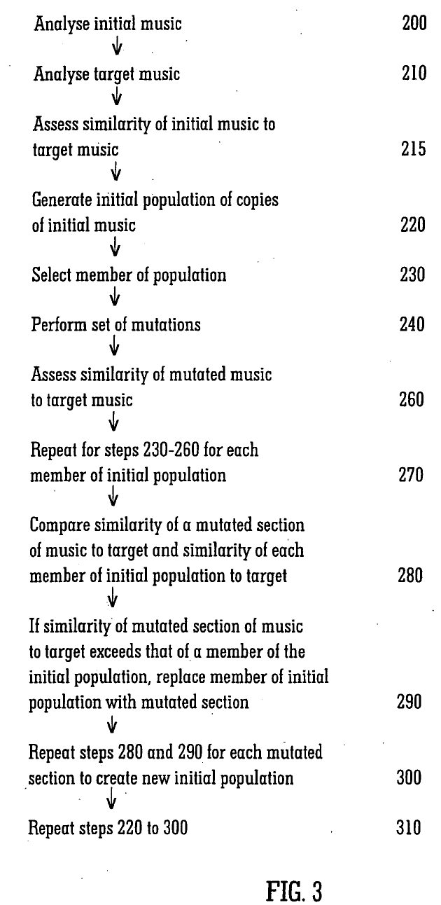

The manner in which each block generates modified music will now be described in more detail with reference to FIG. 3.

On receiving a target section of music, a block carries out an analysis of the received target music and its initial stored music using music analysing means 14 (steps 200, 210).

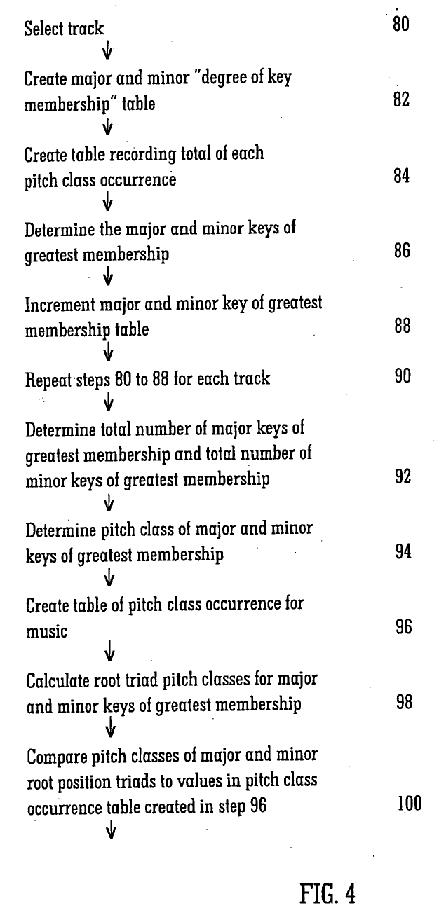

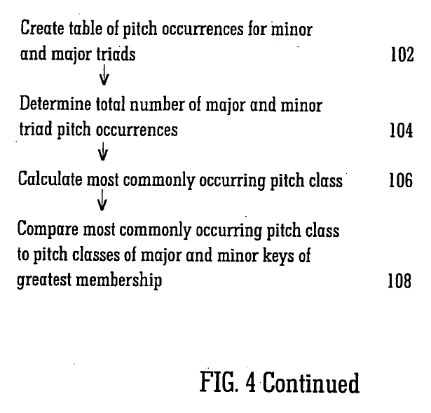

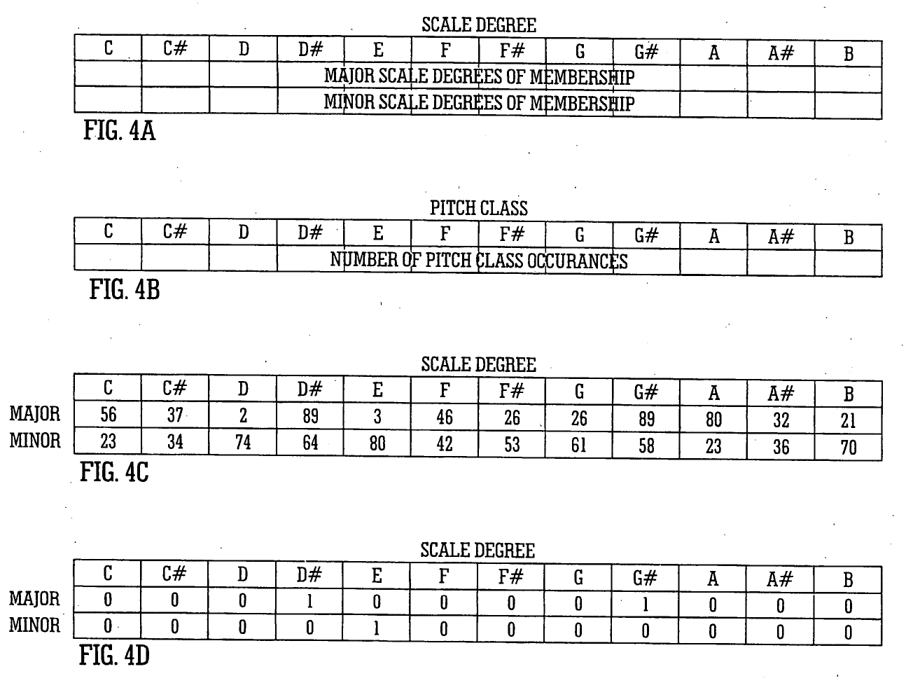

Operation of the music analysing means 14 will now be described in more detail with reference to FIG. 4, which illustrates the way in which harmonic analysis of the music is performed.

The music analysing means comprises a music analysing algorithm. The algorithm first selects a track to analyse (step 80). The algorithm then creates major and minor “degree of key membership” tables for the track as shown in FIG. 4a (step 82). Each key has a scale associated with it. For example, the key of C major has associated scale C major which comprises the pitch classes C, D, E, F, G, A, B. The “degree of key membership” table is completed by counting the number of occurrences in the track of each of the pitches associated with each of the possible major and minor scales C, C#, D, D#, E, F, G, G#, A, A#, B related to each of the possible keys to which the track may belong.

For example the scale of D major comprises the pitch classes D, E, F#, G, A, B and C#. If the analysis algorithm comes across the pitch F# in the track being analysed, the number of pitches present in the scale of D major in the major scale degrees of membership table is incremented by one. This is repeated for each possible scale. This is preferably done by incrementing each possible scale to which a pitch may belong when the pitch is found in the music being analysed. Thus in the above example, in addition to incrementing the D major scale, any other scale containing an F# pitch class, for example A major, will also be incremented. If the algorithm then finds an A pitch in the track being analysed, the number of pitches associated with the scale of D major will again be incremented by one, as will any other scale containing an A pitch class. In this way, a degree of key membership table is created giving the relative numbers of occurrences of pitches associated with the scales related to each of the possible major and minor keys of the track.

As the major/minor “degree of key membership” table is created, the algorithm simultaneously maintains a total for each pitch class occurrence in the track (FIG. 4b) (step 84). For example, whenever the analysis algorithm finds a pitch F# in the track, the number of occurrences of pitch class F# in the pitch class table is incremented by one.

The analysis algorithm then uses the major and minor scale degrees of key membership table to determine the major and minor key or keys of greatest membership (step 86). For example, if the degree of key membership table produced after analysis of the track is as shown in FIG. 4C, the track has two major scales of greatest membership, D# and G#, and one minor scale of greatest membership, E. The algorithm may be set to take only the key with the highest number of associated pitch occurrences as the key of greatest membership, or may, for example, select all keys with pitch occurrences above a predetermined threshold, or within a predetermined margin of the key with the greatest number of occurrences. In this regard, the analysis is not intended to assign a single key to the music, but instead to determine those keys to which it belongs to a greater extent than others. The algorithm uses this information to create a further table recording the major and minor keys of greatest membership information derived for the music (FIG. 3d) (step 88).

The algorithm repeats steps 80-88 for each track present in the music, creating separate major and minor key membership tables for each track, and incrementing the overall key of greatest membership table for the music as each track is analysed. For example, if after analysis of track 2, the track is found to have D# as the major key of greatest membership and a minor key of greatest membership which is G, the algorithm will increment the major scale degree of greatest membership D# by one in FIG. 4d, and the minor scale degree g by one. The overall major key with the greatest degree of membership after analysis of two tracks would then be D#, and there would be two minor keys of greatest membership, E and G.

to determine the mode of the music, i.e. whether it is major or minor. The total number of major keys of greatest membership and the total number of minor keys of greatest membership for the music is first determined. This is done by summing the total number of major and minor keys in the major and minor key of greatest membership table (FIG. 4d) after each of the tracks present in the music has been analysed. If the sum of the major keys of greatest membership is greater than that of minor keys of greatest membership, the music is considered to be major, and vice versa. For example, if the music consisted only of the track analysed in FIG. 4d then there are two major keys of greatest membership and only one minor key of greatest membership. The music would then be taken to be major.

The algorithm then proceeds in step 94 to determine the pitch class of the major and minor keys of greatest membership for the music from the table of major and minor keys of greatest membership (FIG. 4D) obtained after analysis of all tracks. In step 96 the algorithm creates a new table of pitch class occurrence for the music as a whole by summing the values obtained in the tables of pitch class occurrence created in step 84 for each of the individual tracks.

The algorithm then proceeds to conduct a further test to determine whether the music is major or minor. In step 98 the algorithm calculates the root position triad pitch classes for each major and minor key of greatest membership of the music determined in step 94. For example, if the music was found to have a major key of greatest membership which was C and a minor key of greatest membership which was F, then the pitch classes of the root position triads of those keys would be the first, third and fifth notes of the associated scales, i.e. C, E and G for the major triad and F, G# and C for the minor triad. In step 100 the algorithm then compares the pitch classes of the major and minor triads identified to the pitch class occurrence values in the Table created in step 96. The algorithm creates a table giving the total number of pitch occurrences for each of the minor and major triads present in the music (step 102). In step 104 the algorithm compares the total number of major triad pitch occurrences to the total number occurrences of pitches associated with the minor triad. If the total number of occurrences of pitches present in the major triad exceeds that of the minor triad, then the mode of the music is taken to be major, and vice versa. This result may override the result previously determined for the mode of the music in step 92.

In step 106 the most commonly occurring pitch class in the music is calculated using the information in the table of pitch class occurrence created in step 96. The algorithm then carries out a final test of the mode of the music. If the pitch class of the major key of greatest membership determined in step 94 is the same as the most commonly occurring pitch class determined in step 106, the mode is set to major. Conversely, if the pitch class of the minor key of greatest membership is the same as the most frequently occurring pitch class, then the mode is set to minor. If neither is the case, then the mode determined by reference to the total number of major and minor triad pitch occurrences in step 104 is taken to be the mode of the music.

The music analysing algorithm may also analyse the rhythmic and dynamic structure of the music. This may be done by creating a Table storing e.g. duration and velocity i.e. dynamic information for each note present in each track of the music. In some arrangements the initial music stored by the block 1 will be provided in the form of an array of section and note information already in this form.

Returning to FIG. 3, after analysing the initial and target music in steps 200 and 210, the music composing means 16 assesses the similarity of the initial music to the target music (step 215). This is done by comparing the velocity, pitch and duration values for each note in the initial music to the correspondingly positioned notes in the target music. If any of these parameters matches the corresponding parameter in the target music, the note is assigned a target fitness of 1 for that property in the mutated music. If a particular property of a note in the initial and target music does not match, then the property is assigned a target fitness of 0. The overall fitness of the initial music is calculated by summing the number of notes in the initial music having a fitness of 1 for a particular property e.g. velocity, pitch, duration. This may be converted to e.g. percentage similarity to the target music by dividing by the total number of notes present in the target music. Separate fitness values may be derived for each of the possible properties of the notes. A total target fitness value may be derived by averaging these values or alternatively the fitness for each property may be considered separately. The fitness values derived may then be stored in association with the relevant notes in the array representing the initial music.

It will be appreciated that assessment of the similarity of music to the target music may be extended beyond a simple yes or no match for various properties of notes, and could include an analysis of note patterns, which could be graded as being closer or further away from note patterns occurring in the target music. For example, an inversion of a melodic pattern found in the target may provide a certain score for fitness of a mutated section to the target, but an exact match of the melodic pattern would score a higher similarity value. In this way, the assessment may more closely model the way in which a human listener might assess similarity of two sections of music.

The algorithm then proceeds to generate a plurality of copies of the initial music associated with the block 1 (step 220). The copies of the initial music therefore form a population of identical music section genotypes on which a genetic algorithm associated with the music composing means 16 may operate to provide the modified music in accordance with the invention. The algorithm then selects one of the copies of the initial music produced in step 220 on which to perform a set of mutations (step 230). In this embodiment, the sequence of mutation operations which can be applied to the initial music are as follows:
1. Add a note
2. Swap two adjacent notes
3. Transpose a note pitch by a random interval
4. Transpose a note pitch by an octave
5. Mutate the velocity (volume) of a note
6. Move a note to a different position
7. Reverse a group of notes within a randomly selected start and end point
8. Invert notes around an axis defined by the pitch of the starting note within a randomly selected start and end point.
9. Mutate the duration of a note
10. Delete a note

The genetic algorithm applies some or all of these operations to individual or groups of notes in the music sections in accordance with user specified, or pre-set rules. The algorithm preferably selects at least some of the operations relating to mutation of note pitches by reference to information derived from the harmonic analysis of the target music in step 210. For example, the algorithm may refer to the major and minor degrees of key membership tables derived for the target music tracks in step 88 of FIG. 4, and as shown in FIG. 4C, to derive weighting values for weighting the scales from which new pitches should be selected to increase the probability of the pitch of a mutated note matching the pitch of the correspondingly positioned note in the target music. For example, if the major and minor key of greatest membership table for track 1 of the target music was as shown in FIG. 4c, then the algorithm may deduce that the pitch of a note undergoing mutation in track 1 of the initial music should be drawn from the scale of D# or G# major to have the greatest probability of matching a pitch in the target music. The same type approach may be applied when selecting a pitch for a new note to be added to the initial music.

Having selected the scales to draw the pitch of the mutated notes from, the algorithm may then additionally use the information in the pitch class occurrence table for the relevant track (step 84 FIG. 4) to determine the pitch of the note within the scale which should be selected to result in the pitch having the greatest probability of matching the pitch of a note in the target music. The algorithm may if desired also consider the pitch class and key of greatest membership information for the target music as a whole when selecting pitches of notes of a particular track in the mutated initial music, so as to increase the likelihood of the note fitting into a chord in the target music, and thus match a harmony present in the target music.

The duration and velocity of mutated notes may also be selected by reference to the target music in a similar way to the pitches of notes. However, it has been found that it is generally acceptable to allow the system greater freedom in the selection of mutations relating to the rhythmic and dynamic structure of the music than its harmonic structure, as a greater degree of “rhythmic or dynamic noise” may be tolerated in the modified music than harmonic noise.

As mentioned above, the music composing blocks preferably also carry out their composition processes with reference to an overall output section of music, which is produced when modified sections of music produced by a plurality of blocks in the system are played simultaneously. This may be achieved by selecting mutation operations or results to be applied to the initial music of the block with reference to the features of this overall section of music, in addition to the features of the target music supplied to the block.

In a preferred embodiment, which will now be described with reference to FIGS. 5a and b, 6a-e and 7a-e, the features of the overall section of music are specified in the form of a number of graphs illustrating the development of certain parameters describing the character of the music with time.

The development of the dynamic character of the desired overall output music with time is shown in FIG. 5a. This graph illustrates the change in volume with time from the start of the section of overall music, showing that the volume in this case is to gradually increase, reaching a peak around half through the section, before gradually decreasing once more.

A graph describing the harmonic character of the overall music is shown in FIG. 5b. In this graph, the y axis illustrates the dissonance level of the music. Thus, the dissonance of the music is initially relatively low, before increasing to reach a peak around a third of the way into the section of music, before gradually decreasing throughout the remainder of the section of music. Thus the music is initially relatively harmonic, then becoming more dissonant, before gradually returning towards a more harmonic character towards the end.

Alternatively, the system may allow a user to specify a key, which all of the blocks are to use when composing modified music. This control would override the harmonic character profile of FIG. 5B, and result in all of the modified music which is played by the blocks, and which forms part of the overall output music, being in the same key, irrespective of the key of the initial music associated with the blocks.

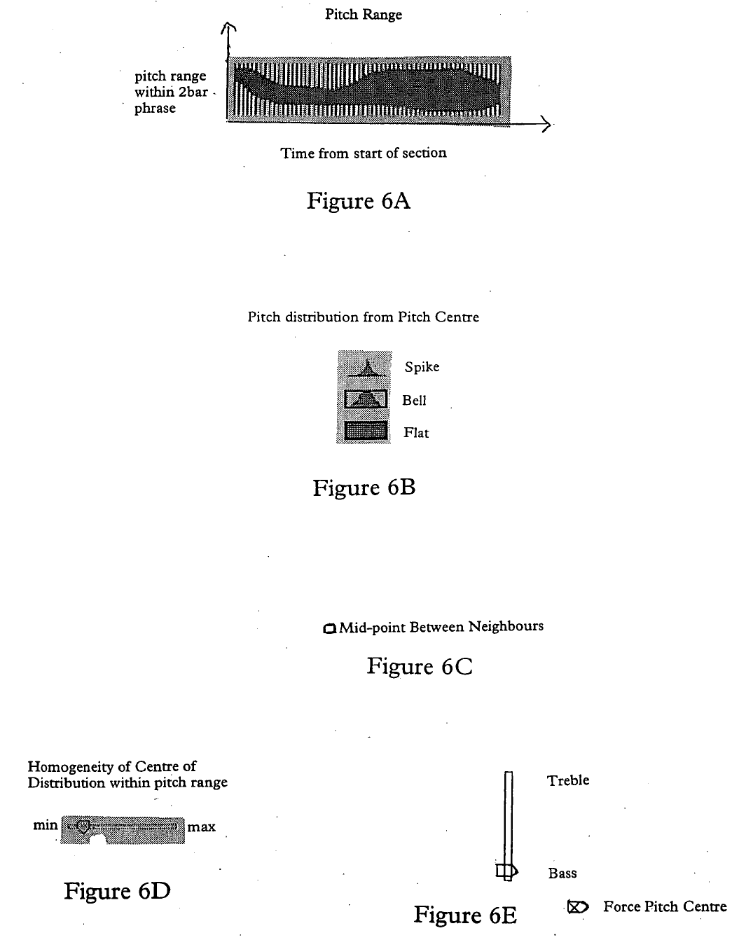

FIG. 6a illustrates a further graph showing a possible pitch profile for the output music. This graph illustrates the pitch range within which notes should be selected at a given time to create a desired overall output. In FIG. 6a, the upper and lower bar charts act to define the upper and lower limits of the range from which a pitch may be selected at a given time from the start of the section. Thus, the pitches of a modified section of music which is to define a phrase in the overall music should be chosen to lie within the range defined by the upper and lower limits set by the graph in FIG. 6a for that particular time.

FIG. 6b illustrates three possible pitch distributions which may be selected by a user to be used by the system when selecting pitches for new notes within the pitch range specified by the graph of FIG. 6a. Thus, the blocks will select a particular pitch point as a pitch centre within the allowable range of FIG. 6a, and then select pitches for notes to be added when mutating music, or whose pitches are to be mutated such that the new pitches lie within a distribution of the type selected in FIG. 6b around that central pitch point. The spiked distribution would result in pitches being concentrated around a pronounced peak at the central point selected by the block. A bell distribution would result in a broader distribution than the spiked distribution, while a flat distribution would provide an even distribution of pitches throughout the allowed range. It is envisaged that more than one distribution might be selected by a user. In this case, the blocks would then attempt to create an even balance between distributions, with approximately equal numbers of blocks selecting each distribution type. In FIG. 6b, both the bell and flat distributions are selected, and the blocks would therefore use either the bell or flat distribution, with roughly equal numbers selecting each distribution type.

FIG. 6c illustrates a further option, midpoint between neighbours, which may be selected by a user. If this option is selected, each block will try to locate a new pitch so that it lies within a range defined by the preceding pitch and a subsequent pitch. This will therefore result in a pitch pattern in the modified music which tends to include more smoother melodies with smaller intervals between the pitches of consecutive notes.

FIG. 6d illustrates a further parameter, the homogeneity of the centre of distribution within the pitch range which may be set by a user between a minimum and maximum level. As mentioned above, each block will pick a pitch to be the centre of the pitch distribution within the pitch range indicated by the graph of FIG. 6a. The homogeneity of centre of distribution within pitch range control allows the user to define the extent to which a block will try to find a similar central point for its pitch distribution to that of other blocks, or whether the blocks will attempt to find centres for the pitch distributions which are spread among the range of values indicated by FIG. 6a.

If the homogeneity value is set to a high value, each block will attempt to set its pitch distribution centre point to a value similar to that of other blocks. A low value will result in the block selecting a value which is different to that of other blocks. Thus, the homogeneity of centre of distribution within pitch range parameter allows the user to specify whether the blocks should attempt to achieve the widest spread of pitches within the allowed pitch range, or a relatively uniform distribution.

Alternatively, the user may override the homogeneity of centre of distribution setting, and specify a forced pitch centre. In this case, as shown in FIG. 6e, the user may select a pitch centre within the range of values from base to treble pitches. The blocks will then all attempt to centre their pitch distributions around this value, which will then over ride any homogeneity value specified in FIG. 6d. The upper and lower limits of the pitch centre setting of FIG. 6e will be defined by the allowed upper and lower limits of pitch range indicated in FIG. 6a.

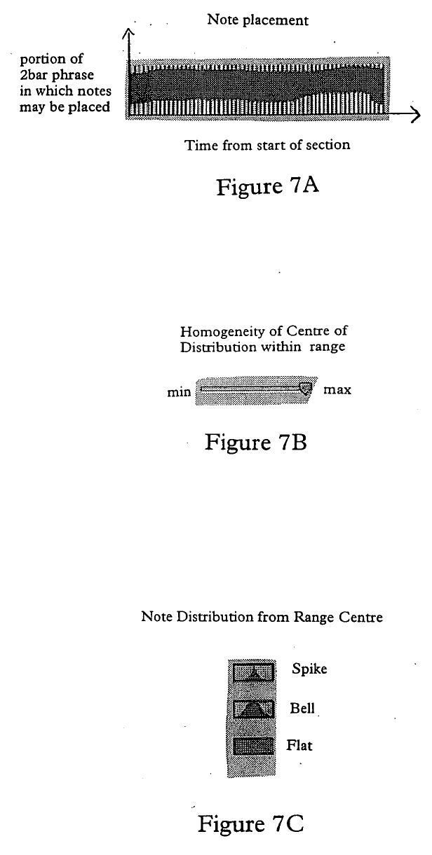

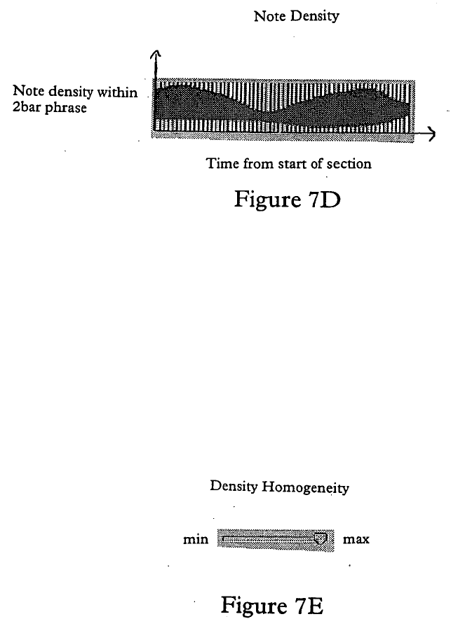

FIG. 7a shows an exemplary graph which may be used to indicate the placement of notes within phrases composed by the blocks to achieve a desired output. The space between the limits defined by the upper and lower bar charts in FIG. 7a indicates that portion within a two bar phrase in which a note may be placed at a given time from the start of the section. Thus, in accordance with FIG. 7a, it will be seen that initially the allowed phrase portion remains fairly uniform in length, with notes being allowed to be placed throughout the two bar phrase, except towards its beginning and end points. The part of the phrase prohibited by the upper limit of the lower of the bar charts is slightly greater than the region of the phrase prohibited by the upper bar chart, and therefore notes may be placed closer to the end of the phrase than to its beginning. Towards the end of the section of music the allowed phrase portion decreases slightly, as the bar chart whose upper limit defines the closest point to the beginning of the phrase at which notes may be placed increases in height.

FIG. 7b illustrates a homogeneity of centre of distribution within range setting, which may operate in a similar way to the homogeneity of centre of distribution within pitch range setting described above in relation to FIG. 6d. Thus, the user may set the homogeneity of centre of distribution value to a minimum setting in order to cause blocks to try to find different points within the allowed phrase portion about which to centre a note distribution. If the control is set to a high value, the blocks will try to find similar central points within the allowed phrase portion defined in FIG. 7a, about which to distribute notes.

FIG. 7c illustrates distributions which may be specified as with the pitch distributions discussed above in relation to FIG. 6b, for use by the blocks when placing notes within the parts of the phrase allowed by the profile specified in FIG. 7a.

FIG. 7d illustrates an example of a graph showing a note density against time profile for the output music. Thus, the upper and lower limits set by the upper and lower bar charts specify the upper and lower limits of an allowed range from which a note density may be selected by the blocks at a particular time from the start of the section. In this example, the allowed note density range is initially quite broad, before narrowing in the middle of the output music section, to require notes to be placed within a narrow range of density, concentrated around a low density value, before increasing again in the second half of the section. The blocks may select any point in the allowed range about which to centre a note density distribution, which may be e.g. of the type shown in FIG. 7C.

FIG. 7e illustrates a density homogeneity control which may allow the user to specify the extent to which blocks attempt to select points to centre note density distributions about within the allowed range which are close to the points selected by other blocks, or conversely, to try to achieve a wide spread in the centres selected for the note density distributions within the allowed range of FIG. 7d.

It will be appreciated that if some or all of the above information shown in FIGS. 5-7 is provided to describe the features of an overall section of music which the modified outputs of the individual blocks are to define when played simultaneously, then the information will be used by the blocks to select some or all mutation operators applied to the initial music. Thus, the pitch information shown in FIGS. 6a-e will mainly be used when selecting mutation operators to be applied to note pitches, for example when adding a note, or exchanging notes. Similarly the note placement information given in FIGS. 7a-e will be used mainly when moving a note to a new position or adding a new note.

It will be appreciated that in some situations, the development of the modified music produced by the system might be entirely specified by the user by means of parameters for the whole system set as described with reference to FIGS. 5-7, rather than by physically changing the way in the blocks are interfaced with one another. Such an arrangement might be suitable particularly when the system comprises a very large number of blocks.

Generally different blocks may take different lengths of time to apply a set of mutation operations, depending, for example, on the number, and nature of the operations applied. The blocks may therefore refer to the various profiles describing the development of the overall output music against time before applying each mutation operator, to retrieve the appropriate information for that particular timeframe, or to a section of the output profile relating to an estimated time in the future when it is anticipated that the block will be ready to output its modified music. The length of the output music may be specified by a user. In a preferred embodiment, different profiles are stored to describe properties of different sections of output music which may be selected by a user.

By allowing the system greater freedom in selecting and applying at least certain mutation operators, the likelihood that the mutated music will evolve in a surprising or more musically interesting manner is increased. The extent to which the system is constrained in its selection of mutation apparatus either by user supplied weightings or by reference to the target music or a desired overall output section of music may be set as desired, depending upon the extent to which it is desired for the modified music produced to adhere to any particular structure, or evolve towards the target.

Returning now to FIG. 3, after carrying out all of the mutations on the initial music, the similarity of the mutated music produced to the target music is determined (step 260). This is done in the same way as the similarity of the initial music to the target music was assessed in step 215 by comparing the velocity, pitch and duration values for each note in the mutated music to the correspondingly positioned notes in the target music. If any of these parameters matches the corresponding parameter in the target music, the note is assigned a target fitness of 1 for that property in the mutated music. If a particular property of a note in the modified and target music does not match, then the property is assigned a target fitness of 0. The overall fitness of the modified music is calculated by summing the number of notes in the mutated music having a fitness of 1 for a particular property to the total number of notes in the target. Fitness values may be derived for each of the possible properties of the note. A total target fitness value may be derived by averaging these values or alternatively the fitness for each property may be considered separately. These values may be used to determine percentage of fitness of the mutated music to the target for each of the parameters, i.e. velocity, pitch, and duration. The fitness values may be stored for each property in association with the note information in the array representing the modified music.

Steps 230 to 260 are repeated for each of the members of the population of initial music to create a new population of mutated musical sections (step 270). If desired, cross over operators may be applied to exchange note patterns between members of the mutated population, and the similarity of each mutated musical section reassessed relative to the target music.

The similarity of each mutated section of music relative to the target music is then compared to the similarity of each member of the initial population of music to the target (step 280). If the similarity of a mutated section of music to the target music exceeds the similarity of a member of the initial population to the target music, then the mutated music replaces that member of the initial population. If the similarity of a mutated section of music is not greater than that of a member of the initial population of music, the mutated section of music is discarded. The comparison of mutated and initial sections of music may be conducted after all of the mutated sections have been produced, or could be carried out on a section by section basis as each mutated music section is produced. In this way, a new initial population of music is created (step 290). The algorithm then repeats steps 220 to 300 with the new initial population (step 310). Alternatively or additionally, the algorithm may refer to the properties of the output music specified for that timeframe to determine whether or not to retain a mutated section of music.

In determining which mutation operations to apply to a mutated section, the results of the previous similarity assessment of the mutated section to the target are used to increase the likelihood that further mutations result in the mutated music evolving closer to the target. For example, if a note in the mutated section had previously been assigned a fitness value of 1 for a particular property, any further mutation operations applied to the mutated music are selected so as to result in that property of the note remaining unchanged. The output music profile is may alternatively or additionally be used to select mutation operations or results as described above.

The algorithm continues to mutate successive generations of populations of mutated music until a mutated section of music having a predetermined level of similarity relative to the target music is obtained. For example, this might be when an overall similarity for each of the properties of the mutated music to the target reaches 25%, or, for example, when the similarity of e.g. the pitch reaches 25%. At this time, the mutated section is transmitted as the modified music of the block to other blocks interfaced with the block to become the target music in a composition process carried out by another block of the system as described in relation to FIG. 2. Thus, the modified music is used by other blocks in the system as the target in a transformation process carried out on their own initial music to produce modified music of a predetermined similarity to the target. This process is repeated, with modified music being transmitted by one block to become the target music of another block in the system in a chain-like manner as many times as desired. The number of links in the chain may be, e.g. preset by the user. After the predetermined number of composition processes in the chain has been completed, the modified music of a block is output to its audio output means 6 for assessment of the results of that chain of composition by the user.

In a preferred embodiment, the level of similarity of the modified music output by a block to its target decreases with each link in the chain. Thus, referring to FIG. 2, block 30 may output modified music M₃ which is 50% similar to its target I₂. Block 40 then composes M₄ based on I₄ and with M₃ as its target, outputting M₄ when it is 40% similar to M₃. Finally, block 50 then composes M₅ based on I₅ and with M₄ as its target, outputting M₅ when it is 30% similar to M₄. In this way, the influence of the initial music of block 20 at the start of the chain decreases on composition processes occurring in the system with distance from block 20.

In other embodiments, the genetic algorithm of each block may continue to operate after a section of modified music of predetermined similarity to the target has been produced, producing mutated sections of music until a mutated section of another greater predetermined level of similarity to the target, is produced. At this stage, the new mutated music may be output as the new modified music of the block. For example, the block may output new modified music every time a mutated section with a similarity of 10% closer to the target is produced.

It will be appreciated that although the music composing modules in the preferred embodiments described above are in the form of physical blocks, the modules may exist only as virtual blocks implemented in software that appear, e.g. as user movable and manipulatable icons on a display screen.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A system for composing music, comprising:
a plurality of music composing modules, each module comprising a processor for composing a modified section of music using initial and target music sections provided to the music composing module;
the plurality of music composing modules each comprising an interface whereby the modules can be interfaced with one another such that the initial, target, or modified music section of a first music composing module interfaced with a second music composing module becomes the initial or target music section for the second music composing module.

2. The system of claim 1, wherein each music composing module is a physical block which may be manipulated by a user.

3. The system of claim 1, wherein each music composing module comprises a detector for detecting when it is interfaced with another module of the system.

4. The system of claim 1, wherein the initial or modified music section of the first music composing module becomes the target music section of the second module.

5. The system of claim 1, wherein each music composing module comprises a receiver for wirelessly receiving a music section from another music composing module of the system and a transmitter for wirelessly transmitting a music section to another music composing module of the system when interfaced with the another music composing module.

6. The system of claim 1, wherein the system comprises a wireless Local Area Network and each music composing module comprises a transmitter for transmitting music sections to other modules of the system over the Local Area Network and a receiver for receiving music sections over the Local Area Network.

7. The system of claim 1, wherein each music composing module comprises a memory for storing an initial music section which remains associated with the module at all times in use.

8. The system of claim 7, further comprising:
a transmitter for transmitting output music information to the music composing modules and wherein the processor of each said music composing module uses the output music information when composing a modified section of music.

9. The system of claim 1, wherein the system comprises a network manager for controlling the operation of a music composing module when it is interfaced with another module or modules.

10. The system of claim 1, wherein each music composing module comprises a processor for composing a modified music section on the basis of the initial and target music sections using a genetic algorithm by mutating the initial music section with reference to the target music section.

11. The system of claim 10, wherein each music composing module comprises a processor for assessing the similarity of a mutated music section to the target music section, and a processor for determining whether to retain the mutated music section on the basis of the similarity assessment.

12. The system of claim 11, wherein each music composing module comprises a processor for outputting the mutated music section as the modified music of the module when the similarity of the mutated music section to the target music section reaches a selected level.

13. The system of claim 1, further comprising:
a transmitter for transmitting output music information to the music composing modules and wherein the processor of each said music composing module uses the output music information when composing a modified section of music.

14. The system of claim 1, wherein each music composing module comprises a processor for carrying out a harmonic analysis of a section of music.

15. The system of claim 14, wherein the processor determines a degree of key membership of the music.

16. A system for composing music, comprising:
a plurality of music composing modules, each module comprising a processor for composing a modified section of music using initial and target music sections provided to the music composing module;
each music composing module further comprising a transmitter for automatically transmitting a modified music section it composes to another music composing module of the system, and a manually operable transmitter for transmitting its initial section of music to another module of the system only on the intervention of a user.

17. The system of claim 16, wherein each music composing module comprises a memory for storing an initial music section which remains associated with the module at all times in use.

18. The system of claim 16, wherein each music composing module comprises a processor for composing a modified music section on the basis of the initial and target music sections using a genetic algorithm by mutating the initial music section with reference to the target music section.

19. A system for composing music comprising:
a processor for storing an initial section of music;
a processor for storing a target section of music;
a processor for mutating the initial section of music to produce a mutated section of music;
a processor for assessing the similarity of the mutated section of music to the target section of music and a processor for determining whether to retain the mutated section of music on the basis of said assessment;
a processor for repeating the above steps with the mutated section of music becoming the new initial section of music; and
a processor for terminating the process when a mutated section of music having a given, non-identical, degree of similarity to the target section of music is produced.

20. A system for composing music, the system comprising:
a plurality of music composing modules, each module comprising a processor for composing a modified section of music using an initial section of music provided to the music composing module and a memory for storing an initial section of music; and
a transmitter for transmitting information to describe an output section of music to be produced to each of said plurality of modules;
each music composing module further comprising a processor for mutating the initial section of music to produce a mutated section of music and a processor for using the output music information to determine whether to retain the mutated section of music.

21. A system for composing music comprising:
a plurality of music composing modules, each module comprising a processor for composing a modified section of music by mutating an initial section of music provided to the music composing module, and a memory for storing an initial section of music; and
a transmitter for transmitting information to describe at least one property of an output section of music to be produced to said plurality of music composing modules;
wherein each of said plurality of music composing modules comprises a processor for using the output music information provided when producing said modified music.

22. A system for the harmonic analysis of a section of music, comprising:
a processor for specifying a scale comprising a pattern of pitches; and
a processor for determining the number of occurrences in the music section of notes having the pitches associated with the scale for each of a plurality of keys of the scale, and a processor for deriving a degree of membership of the music section to each of the plurality of keys using the pitch occurrence information.

23. A system for composing music, comprising:
a plurality of music composing modules, each module comprising means for composing a modified section of music using initial and target music sections provided to the music composing module;
the plurality of music composing modules each comprising interfacing means whereby the modules can be interfaced with one another such that the initial, target, or modified music section of a first music composing module interfaced with a second music composing module becomes the initial or target music section for the second music composing module.

24. A system for composing music, comprising:
a plurality of music composing modules, each module comprising means for composing a modified section of music using initial and target music sections provided to the music composing module;
wherein:
each music composing module is arranged to automatically transmit a modified music section it composes to another music composing module of the system and to transmit its initial section of music to another module of the system only on the intervention of a user.

25. A system for composing music comprising:
means for providing an initial section of music;
means for providing a target section of music;
means for mutating the initial section of music to produce a mutated section of music;
means for assessing the similarity of the mutated section of music to the target section of music to determine whether to retain the mutated section of music;
means for repeating the above steps with the mutated section of music becoming the new initial section of music; and
means for terminating the process when a mutated section of music having a given, non-identical, degree of similarity to the target section of music is produced.

26. A system for composing music, the system comprising:
a plurality of music composing modules, each module comprising means for composing a modified section of music using an initial section of music provided to the music composing module;
means for providing each music composing module with an initial section of music; and
means for providing information to describe an output section of music to be produced;
each music composing module further comprising means for mutating the initial section of music to produce a mutated section of music and means for using the output music information to determine whether to retain the mutated section of music.

27. A system of composing music comprising:
a plurality of music composing modules, each module comprising means for composing a modified section of music by mutating an initial section of music provided to the music composing module;
means for providing an initial section of music to each of said plurality of music composing modules;
means for providing information to describe at least one property of an output section of music to be produced;
wherein each of said music composing modules further comprises means for using the output music information provided when producing said modified music.

28. A system for the harmonic analysis of a section of music, comprising:
means for specifying a scale comprising a pattern of pitches; and
means for determining the number of occurrences in the music section of notes having the pitches associated with the scale for each of a plurality of keys of the scale to thereby derive a degree of membership of the music section to each of the plurality of keys.

29. A method of composing music using a plurality of music composing modules, each module comprising means for composing a modified section of music using initial and target music sections provided to the music composing module, the method comprising:
interfacing one or more of the music composing modules with one another such that the initial, target, or modified music section of a music composing module interfaced with another music composing module becomes the initial or target music section for the another music composing module.

30. The method of claim 29, wherein the step of interfacing the music composing modules comprises bringing the modules within a selected range of one another.

31. The method of claim 29, wherein the initial or modified music section of one module becomes the target music section of the other, interfaced module.

32. The method of claim 29, wherein each music composing module automatically transmits its modified music section to another module of the system.

33. The method of claim 29, comprising supplying each music composing module with an initial music section which remains associated with the module at all times in use.

34. The method of claim 29, further comprising controlling the operation of each music composing module when it is interfaced with another module or modules of the system using a network manager.

35. The method of claim 29, wherein the step of composing the modified music comprises deriving corresponding information for the initial and target music sections, and using the derived information to determine a set of rules for composing modified music based on the initial and target music sections.

36. The method of claim 29, further comprising the music composing modules using a genetic algorithm to compose their modified music sections on the basis of the initial and target music sections by mutating the initial music section with reference to the target music section.

37. The method of claim 36, wherein each music composing module assesses the similarity of a mutated music section to the target music section.

38. The method of claim 37, wherein each music composing module produces a plurality of mutated sections of music from a plurality of copies of the initial music and admits a mutated section of music into the population if the similarity of the mutated section of music to the target music exceeds the similarity of an existing member of the population of music sections to the target music section.

39. The method of claim 37, comprising outputting a mutated section of music as the modified music section when the similarity of the mutated music to the target music section reaches a selected level.

40. The method of claim 36, comprising terminating the genetic algorithm when a mutated section of music that has a predetermined non-identical degree of similarity to the target music is produced.

41. The method of claim 29, comprising providing output music information to described the development of at least one property of an output section of music to be produced by the plurality of modules.

42. The method of claim 29, comprising each music composing module using the output music information when composing the modified music section.

43. The method of claim 29, comprising each music composing module carrying out at least a harmonic analysis of a music section.

44. The method of claim 42, wherein said harmonic analysis comprises a step of determining a degree of key membership of the music.

45. A method of composing music using a plurality of music composing modules, each module comprising means for composing a modified section of music using initial and target music sections provided to the music composing module, the method comprising:
providing each module of the system with an initial section of music;
a module transmitting its initial section of music to another music composing module such that the initial music section of the module becomes the target music of the another music composing module;
another music composing module composing a modified section of music using the initial section of music transmitted by the first music composing module as its target music section; and
repeating the above transmitting and composing steps a given number of times with the modified section of music of the another music composing module becoming the target music of a further music composing module.

46. The method of claim 45, comprising supplying each music composing module with an initial music section which remains associated with the module at all times in use.

47. The method of claim 45, further comprising the music composing modules using a genetic algorithm to compose their modified music sections on the basis of the initial and target music sections by mutating the initial music section with reference to the target music section.

48. The method of claim 47, comprising terminating the genetic algorithm when a mutated section of music that has a predetermined non-identical degree of similarity to the target music is produced.

49. The method of claim 45, comprising providing output music information to describe the development of at least one property of an output section of music to be produced by the plurality of modules.

50. The method of claim 45, comprising each music composing module using the output music information when composing the modified music section.

51. A method of composing music using a plurality of music composing modules, each module comprising means for composing a modified section of music using initial and target music sections provided to the music composing module, the method comprising:
providing each module of the system with an initial section of music;
manually intervening to cause a first module to transmit its initial section of music to another music composing module, such that the initial music section of the first module becomes the target music of the another music composing module;
the another music composing module composing a modified section of music using the initial section of music transmitted by the first music composing module as its target music section, and transmitting the modified section of music automatically to another music composing module of the system.

52. The method of claim 5 1, comprising providing output music information to describe the development of at least one property of an output section off music to be produced by the plurality of modules.

53. The method of claim 5 1, comprising each music composing module using the output music information when composing the modified music section.

54. A method of composing music comprising:
providing an initial section of music;
providing a target section of music;
mutating the initial section of music to produce a mutated section of music;
assessing the similarity of the mutated section of music to the target section of music to determine whether to retain the mutated section of music;
repeating the above steps with the mutated section of music becoming the new initial section of music; and
terminating the process when a mutated section of music that has a given, non-identical, degree of similarity to the target section of music is produced.

55. A method of composing music using a plurality of music composing modules, each module comprising means for composing a modified section of music using an initial section of music provided to the music composing module, the method comprising:
providing each music composing module with an initial section of music;
providing information to describe an output section of music to be produced;
each music composing module carrying out the steps of:
mutating the initial section of music to produce a mutated section of music;
and using the output music information to determine whether to retain the mutated section of music.

56. A method of composing music using a plurality of music composing modules, each module comprising means for composing a modified section of music by mutating an initial music section of music provided to the music composing module, the method comprising:
providing an initial section of music to each of said plurality of music composing modules;
providing information to describe at least one property of an output section of music to be produced; and
the music composing modules using the output music section information when composing their modified music sections.

57. A method of composing music using a plurality of music composing modules, each module comprising means for composing a modified section of music using initial and target music sections provided to the music composing module the method comprising:
providing each module of the system with an initial section of music;
a module transmitting its initial section of music to another music composing module, such that the initial music section of the module becomes the target music of the another music composing module;
the another music composing module composing a modified section of music using an initial section of music and the target section of music transmitted by the first music composing module;
and repeating the above transmitting and composing steps a given number of times with the modified section of music of the another music composing module becoming the target music of a further music composing module;
wherein the similarity of the modified music transmitted by a music composing module to its target is less than was the similarity of the modified music section transmitted to that module as the target to its respective target.

58. A method of harmonic analysis of a section of music, comprising:
specifying a scale comprising a pattern of pitches; and
determining the number of occurrences in the music section of notes having the pitches associated with the scale for each of a plurality of keys of the scale to thereby derive a degree of membership of the music section to each of the plurality of keys.

59. A method of composing music using a plurality of music composing modules, each module comprising means for composing a modified section of music using initial and target music sections provided to the music composing module, the method comprising:
interfacing one or more of the music composing module with one another such that the initial, target, or modified music section of a music composing module interfaced with another music composing module becomes the initial or target music section for the another music composing module.

60. A method of composing music comprising:
composing a first modified section of music using initial and target music sections; and
composing a second modified section using initial and target music sections; wherein
the initial or target music sections used to compose the first modified section of music, or the first modified music section of music is used as the initial or target music section,when composing the second modified section of music.

61. A music composing module for use in a music composing system, the module comprising:
a processor for composing a modified section of music using initial and target music sections provided to the music composing module;
a transmitter for transmitting the initial, target, or modified music section of the music composing module to another music composing module; and
a receiver for receiving the initial, target, or modified music section of another music composing module.

62. A music composing module for use in a music composing system, the module comprising:
means for composing a modified section of music using initial and target music sections provided to the music composing module;
means for transmitting the initial, target, or modified music section of the music composing module to another music composing module; and
means for receiving the initial, target, or modified music section of another music composing module.

63. One or more processor readable storage devices having processor readable code embodied on said processor readable storage device, said processor readable code for programming one or more processors to perform a method comprising, composing music using a plurality of music composing modules, each module comprising means for composing a modified section of music using initial and target music sections provided to the music composing module, the method comprising:
interfacing one or more of the music composing modules with one another such that the initial, target, or modified music section of a music composing module interfaced with another music composing module becomes the initial or target music section for the another music composing module.

64. One or more processor readable storage devices having processor readable code embodied on said processor readable storage devices, said processor readable code for programming one or more processors to perform a method comprising composing music using a plurality of music composing modules, each module comprising means for composing a modified section of music using initial and target music sections provided to the music composing module, the method comprising:
providing each module of the system with an initial section of music;
a module transmitting its initial section of music to another music composing module such that the initial music section of the module becomes the target music of the another music composing module;
another music composing module composing a modified section of music using the initial section of music transmitted by the first music composing module as its target music section; and
repeating the above transmitting and composing steps a given number of times with the modified section of music of the another music composing module becoming the target music of a further music composing module.

65. One or more processor readable storage devices having processor readable code embodied on said processor readable storage devices, said processor readable code for programming one or more processors to perform a method comprising composing music using a plurality of music composing modules, each module comprising means for composing a modified section of music using initial and target music sections provided to the music composing module, the method comprising:
providing each module of the system with an initial section of music;
causing a first module to transmit its initial section of music to another music composing module on manual intervention, such that the initial music section of the first module becomes the target music of the another music composing module;
the another music composing module composing a modified section of music using the initial section of music transmitted by the first music composing module as its target music section, and transmitting the modified section of music automatically to another music composing module of the system.

66. One or more processor readable storage devices having processor readable code embodied on said processor readable storage devices, said processor readable code for programming one or more processors to perform a method comprising composing music comprising:
providing an initial section of music;
providing a target section of music;
mutating the initial section of music to produce a mutated section of music;
assessing the similarity of the mutated section of the music to the target section of music to determine whether to retain the mutated section of music;
repeating the above steps with the mutated section of music becoming the new initial section of music; and
terminating the process when a mutated section of music that has a given, non-identical, degree of similarity to the target section of music is produced.

67. One or more processor readable storage devices having processor readable code embodied on said processor readable storage devices, said processor readable code for programming one or more processors to perform a method comprising composing music using a plurality of music composing modules, each module comprising means for composing a modified section of music using an initial section of music provided to the music composing module, the method comprising:
providing each music composing module with an initial section of music;
providing information to describe an output section of music to be produced;
each composing module carrying out the steps of:
mutating the initial section of music to produce a mutated section of music;
and using the output music information to determine whether to retain the mutated section of music.

68. One or more processor readable storage devices having processor readable code embodied on said processor readable storage devices, said processor readable code for programming one or more processors to perform a method comprising composing music using a plurality of music composing modules, each module comprising means for composing a modified section of music by mutating an initial music section of music provided to the music composing module, the method comprising:
providing an initial section of music to each of said plurality of music composing modules; providing information to describe at least one property of an output section of music to be produced; and
the music composing modules using the output music section information when composing their modified music sections.

69. One or more processor readable storage devices having processor readable code embodied on said processor readable storage devices, said processor readable code for programming one or more processors to perform a method comprising composing music using a plurality of music composing modules, each module comprising means for composing a modified section of music using initial and target music sections provided to the music composing module the method comprising:
providing each module of the system with an initial section of music;
a module transmitting its initial section of music to another music composing module, such that the initial music section of the module becomes the target music of the another music composing module;
the another music composing module composing a modified section of music using an initial section of music and the target section of music transmitted by the first music composing module;
and repeating the above transmitting and composing steps a given number of times with the modified section of music of the another music composing module becoming the target music of a further music composing module;
wherein the similarity of the modified music transmitted by a music composing module to its target is less than was the similarity of the modified music section transmitted to that module as the target to its respective target.

70. One or more processor readable storage devices having processor readable code embodied on said processor readable storage device, said processor readable code for programming one or more processors to perform a method comprising harmonic analysis of a section of music comprising:
specifying a scale comprising a pattern of pitches; and
determining the number of occurrences in the music section of notes having the pitches associated with the scale for each of a plurality of keys of the scale to thereby derive a degree of membership of the music section to each of the plurality of keys.

71. One or more processor readable storage devices having processor readable code embodied on said processor readable storage devices, said processor readable code for programming one or more processors to perform a method comprising composing music using a plurality of music composing modules, each module comprising means for composing a modified section of music using initial and target music sections provided to the music composing module, the method comprising:
interfacing one or more of the music composing module with one another such that the initial, target, or modified music section of a music composing module interfaced with another music composing module becomes the initial or target music section for the another music composing module.

72. One or more processor readable storage devices having processor readable code embodied on said processor readable storage devices, said processor readable code for programming one or more processors to perform a method comprising composing music comprising:
composing a first modified section of music using initial and target music sections, and
composing a second modified section using initial and target music sections; wherein
the initial or target music sections used to compose the first modified section of music, or the first modified music section of music is used as the initial or target music section when composing the second modified section of music.

73. One or more processor readable storage devices having processor readable code embodied on said processor readable storage devices, said processor readable code for programming a music composing module for use in a music composing system to compose a modified section of music using initial and target music sections provided to the music composing module;
to transmit the initial, target or modified music section of the music composing module to another music composing module; and
to receive the initial, target or modified music section of another music composing module.
